(19) United States
(12) Patent Application Publication
(10) Pub. No.: US 2025/0145500 A1
(43) Pub. Date: May 8, 2025

(54) REGENERATABLE SYSTEM FOR CONTAMINANT REMOVAL

(71) Applicant: Ionic Water Technologies, LLC, Hamilton, NJ (US)

(72) Inventors: George W. ADAMSON, Hamilton, NJ (US); David STEIN, Hamilton, NJ (US); Cassidy Rae SCHNEIDER, Hamilton, NJ (US); Victoria KORN, Hamilton, NJ (US); Melissa WOODWARD, Hamilton, NJ (US)

(21) Appl. No.: 18/720,306

(22) PCT Filed: Dec. 14, 2022
(86) PCT No.: PCT/US2022/081501

§ 371 Date: Jun. 14, 2024

Related U.S. Application Data
(60) Provisional application No. 63/290,231, filed on Dec. 16, 2021.

(51) Int. Cl. C02F 1/28; C02F 1/00; C02F 1/44; C02F 1/52; C02F 1/68; C02F 101/36

(52) U.S. Cl. CPC C02F 1/283; C02F 1/442; C02F 1/5245; C02F 1/68; C02F 2001/007; C02F 2101/36; C02F 2303/16

(57) ABSTRACT

A system and method for water purification by capture of contaminants in an aqueous mixture is described herein. A system and method for regenerating the capture system is also described. An integrated capture and regeneration system and method is also described including a separation vessel that houses a capture bed and optionally an electrode in electrical contact with the bed with a power source for applying a voltage to the electrode. The aqueous wash liquid may contain a counter ion that binds to the contaminant forming an aggregate contaminant phase that separates from the aqueous wash liquid. The capture bed may be treated with a hydroxide and/or a peroxide, e.g., prior to the counter ion binding the contaminant.

### CROSS-REFERENCE TO RELATED APPLICATIONS

This application claims the benefit of U.S. Provisional Application No. 63/290,231, filed on Dec. 16, 2021, the disclosure of which is incorporated herein by reference in its entirety.

### TECHNICAL FIELD

The present invention relates to systems and methods for removing ionic contaminants from an aqueous mixture using a capture bed and for regenerating the capture bed for further use.

### BACKGROUND

This section provides background information related to the present disclosure and is not necessarily prior art.

Water purification technologies are fundamentally important to everyday life. Contaminants must be removed to purify water to an acceptable level in order for the water to be used as drinking water or for other purposes. Per- and polyfluoroalkyl substances (PFAS) are of particular concern and of particular importance to remove from water. Existing technologies for water purification by removal of contaminants, including PFAS, suffer from issues of efficiency and environmental sustainability. For example, technologies that trap contaminants, such as PFAS, in an ion exchange resin or carbon bed currently require replacement of the bed and disposal of the spent bed to a landfill.

Therefore, while there are existing technologies for removing contaminants such as PFAS (and other similar polyfluorinated hydrocarbons) from water, a need continues to exist for improved technologies that provide more effective removal of contaminants and that are regeneratable for continued use without the need for expensive and inefficient replacement of, and environmentally harmful disposal of, system components.

### SUMMARY OF THE INVENTION

In one aspect, disclosed herein is a method of removing a contaminant from an aqueous mixture. The method includes flowing a contaminated aqueous mixture comprising one or more ionic contaminants through a vessel that houses a carbon bed, wherein the one or more ionic contaminants are retained by the carbon bed. The method further includes contacting the one or more ionic contaminants retained by the carbon bed with (a) a hydroxide and/or a peroxide, and (b) one or more cations selected from Ca²⁺, Mg²⁺, Zn²⁺, Sr²⁺, Al³⁺, B³⁺, and Fe³⁺. The (a) hydroxide and/or peroxide, and the (b) one or more cations are provided in a single aqueous liquid or in two or more separate aqueous liquids for contacting the one or more ionic contaminants. The method further includes forming an aggregate contaminant phase comprising the one or more ionic contaminants and isolating the aggregate contaminant phase.

In some embodiments, the aggregate contaminant phase is formed by precipitation, micelle formation, agglomeration, flocculation, flotation, or breaking an emulsion. In some embodiments, the (a) hydroxide and/or peroxide comprises sodium hydroxide. In other embodiments, the (a) hydroxide and/or peroxide comprises hydrogen peroxide. And, in some embodiments, the (a) hydroxide and/or peroxide comprises sodium peroxide.

In some embodiments, the (b) one or more cations comprises Ca²⁺. For example, the Ca²⁺ is provided as calcium hydroxide. In other embodiments, the (b) one or more cations comprises Al³⁺. For example, the Al³⁺ is provided as aluminum sulfate, aluminum hydroxide, or sodium aluminate.

In some embodiments, the (a) hydroxide and/or peroxide are provided in a first aqueous liquid and the (b) one or more cations are provided in a second aqueous liquid. In some embodiments, the first aqueous liquid contacts the one or more ionic contaminants before the second aqueous liquid.

In another aspect, disclosed herein is a method of removing a contaminant from an aqueous mixture, the method comprising flowing a contaminated aqueous mixture comprising one or more ionic contaminants through a vessel that houses an carbon bed, wherein the one or more ionic contaminants are retained by the carbon bed; contacting the one or more ionic contaminants retained by the carbon bed with (a) sodium hydroxide and/or hydrogen peroxide, and (b) calcium hydroxide, aluminum hydroxide, and/or aluminum sulfate; wherein the (a) sodium hydroxide and/or hydrogen peroxide, and the (b) calcium hydroxide, aluminum hydroxide, and/or aluminum sulfate are provided in a single aqueous liquid or in two or more separate aqueous liquids for contacting the one or more ionic contaminants; forming an aggregate contaminant phase comprising the one or more ionic contaminants; and isolating the aggregate contaminant phase.

In some embodiments, the (a) sodium hydroxide and/or hydrogen peroxide are provided in a first aqueous liquid for contacting the one or more ionic contaminants and the (b) calcium hydroxide, aluminum hydroxide, and/or aluminum sulfate are provided in a second aqueous liquid for contacting the one or more ionic contaminants. In some embodiments, the first aqueous liquid contacts the ionic contaminants before the second aqueous liquid.

In some embodiments, the methods further comprise rinsing the carbon bed with an acidic aqueous solution by flowing the acidic aqueous solution through the vessel. In some embodiments, the acidic aqueous solution comprises hydrochloric acid, citric acid, sulfuric acid, nitric acid, or any combination thereof. For example, the acidic aqueous solution may comprise hydrochloric acid. And, in some embodiments, the acidic aqueous solution comprises an acid salt.

In some embodiments, the methods further comprise rinsing the carbon bed with water by flowing water through the vessel. In some embodiments, the water is substantially free of additives.

In some embodiments, the methods further comprise repeating one or more times the steps of (i) contacting the ionic contaminants with the (a) hydroxide and/or peroxide, (ii) contacting the ionic contaminants with the (b) one or more cations, (iii) rinsing with the acidic aqueous solution, and (iv) rinsing with water.

In some embodiments, prior to flowing the contaminated aqueous mixture through the vessel, the methods further comprise pretreating the carbon bed by contacting the carbon bed with (a) a hydroxide and/or a peroxide, and (b) one or more cations selected from Ca²⁺, Mg²⁺, Zn²⁺, Sr²⁺, Al³⁺, B³⁺, and Fe³⁺. In some embodiments, the pretreatment further comprises rinsing the carbon bed with an acidic aqueous solution and rinsing the carbon bed with water.

In some embodiments, the ionic contaminant comprises an organic end with an ionic moiety. For example, the ionic contaminant is selected from the group consisting of a polyfluoroalkyl ion, a borate, a phosphate, a polyphosphate, a sulfate, an organic acid, a fatty acid, a humic substance, a shortchain PFAS, a water-soluble medication, a detergent, a water-soluble insecticide, a water-soluble fungicide, a water-soluble germicide, and any combination thereof. In some embodiments, the ionic contaminant is a polyfluoroalkyl ion. And, in some embodiments, the polyfluoroalkyl ion is perfluorooctanesulfonate or perfluorooctanoate.

In some embodiments, the carbon bed comprises powder, granules, beads, pellets, cloths, felts, nonwoven fabrics, or composites comprising a material selected from carbon, nitrogen-doped carbon, silicon-doped carbon, boron-doped carbon, charcoal, graphite, biochar, coke, carbon black, or any combination thereof. In some embodiments, the carbon bed comprises activated charcoal powder, granules, pellets, beads, or any combination thereof. In some embodiments, the vessel is a pipe, column, or tank. In other embodiments, isolating the aggregate contaminant phase comprises filtration, nano-filtration, or sedimentation.

In some embodiments, the methods further comprise contacting the one or more ionic contaminants with a surfactant. In some embodiments, the surfactant is selected from fatty acids, sulphones, phosphates, polyethers, sulfates, polyols, or any combination thereof. And, in some embodiments, the surfactant is selected from sodium dodecyl sulfate (SDS), sorbitan monolaurate, polyethylene glycol (PEG), or any combination thereof.

In some embodiments, the surfactant contacts the one or more ionic contaminants before the (a) hydroxide and/or peroxide contact the one or more ionic contaminants. In other embodiments, the surfactant contacts the one or more ionic contaminants after the (a) hydroxide and/or peroxide contact the one or more ionic contaminants. And, in some embodiments, the surfactant contacts the one or more ionic contaminants simultaneously with the (a) hydroxide and/or peroxide.

In some embodiments, the methods further comprise contacting the one or more ionic contaminants with an agglomerating agent. In some embodiments, the agglomerating agent comprises an oil, a terpene, a fatty acid ester, or any combination thereof. And, in some embodiments, the agglomerating agent is selected from safflower oil, rapeseed oil, limonene, ethyl octanoate, or any combination thereof.

In some embodiments, the agglomerating agent contacts the one or more ionic contaminants before the (a) hydroxide and/or peroxide contact the one or more ionic contaminants. In other embodiments, the agglomerating agent contacts the one or more ionic contaminants after the (a) hydroxide and/or peroxide contact the one or more ionic contaminants. And, in some embodiments, the agglomerating agent contacts the one or more ionic contaminants simultaneously with the (a) hydroxide and/or peroxide.

In some embodiments, the carbon bed is an activated carbon bed. And, in some embodiments, the carbon bed comprises sintered carbon.

In another aspect, disclosed herein is a method of regenerating a carbon bed, the method comprising providing a vessel that houses an carbon bed having one or more ionic contaminants retained thereon or therein; contacting the one or more ionic contaminants retained by the carbon bed with (a) a hydroxide and/or a peroxide, and (b) one or more cations selected from Ca²⁺, Mg²⁺, Zn²⁺, Sr²⁺, Al³⁺, B³⁺, and Fe³⁺; wherein the (a) hydroxide and/or peroxide, and the (b) one or more cations are provided in a single aqueous liquid or in two or more separate aqueous liquids for contacting the one or more ionic contaminants; forming an aggregate contaminant phase comprising the one or more ionic contaminants; and isolating the aggregate contaminant phase.

In a further aspect, disclosed herein is a method of removing a contaminant from an aqueous mixture. The method comprises flowing a contaminated aqueous mixture comprising one or more ionic contaminants through a vessel that houses a carbon bed, wherein the one or more ionic contaminants are retained by the carbon bed. The method also comprises contacting the one or more ionic contaminants retained by the carbon bed with (a) a hydroxide and/or a peroxide, and (b) one or more cations selected from Ca²⁺, Mg²⁺, Zn²⁺, Sr²⁺, Al³⁺, B³⁺, and Fe³⁺. The (a) hydroxide and/or peroxide, and the (b) one or more cations are provided in a single aqueous liquid or in two or more separate aqueous liquids for contacting the one or more ionic contaminants. The method further comprises contacting the one or more ionic contaminants retained by the carbon bed with an agglomerating agent. The method also further comprises forming an aggregate contaminant phase comprising the one or more ionic contaminants and isolating the aggregate contaminant phase.

In some embodiments, the agglomerating agent comprises an oil, a terpene, a fatty acid ester, or any combination thereof. For example, the agglomerating agent may comprise the oil, and the oil is selected from coconut oil, corn oil, cottonseed oil, olive oil, palm oil, peanut oil, rapeseed oil, safflower oil, sesame oil, soybean oil, sunflower oil, or any combination thereof. In some embodiments, the agglomerating agent comprises the terpene, and the terpene is selected from myrcene, menthol, limonene, carvone, hinokitiol, linalool, or any combination thereof. In some embodiments, the agglomerating agent comprises the fatty acid ester, and the fatty acid ester is ethyl octanoate. And, in some embodiments, the agglomerating agent is selected from safflower oil, rapeseed oil, limonene, ethyl octanoate, or any combination thereof.

In some embodiments, the method further comprises contacting the one or more ionic contaminants with a surfactant. For example, the surfactant may be selected from fatty acids, sulphones, phosphates, polyethers, sulfates, polyols, or any combination thereof. And, in some embodiments, the surfactant is selected from sodium dodecyl sulfate (SDS), polyethylene glycol (PEG), or any combination thereof.

In some embodiments, the method further comprises contacting the one or more ionic contaminants with an antifreeze agent. In some embodiments, the antifreeze agent is selected from the group consisting of propylene glycol, polypropylene glycol, polyethylene glycol, glycerol, polyvinyl alcohol, carboxymethylcellulose, ribose, sucrose, glucose, rhamnose, xylose, fructose, raffinose, stachyose, low molecular weight hydroxyethyl starches, maltodextrin, cellodextrins, and combinations thereof. And, in some embodiments, the antifreeze agent comprises glycerol.

In some embodiments, the method further comprises rinsing the carbon bed with an acidic aqueous solution by flowing the acidic aqueous solution through the vessel. In some embodiments, the acidic aqueous solution comprises hydrochloric acid, citric acid, sulfuric acid, nitric acid, or any combination thereof. And, in some embodiments, the acidic aqueous solution comprises an acid salt.

In some embodiments, (a) hydroxide and/or peroxide are provided in a first aqueous liquid for contacting the one or more ionic contaminants; and (b) the one or more cations are provided in a second aqueous liquid for contacting the one or more ionic contaminants. In some embodiments, the second aqueous liquid further comprises the surfactant and the antifreeze agent. In other embodiments, the second aqueous liquid further comprises the surfactant, the antifreeze agent, and the agglomerating agent. In some embodiments, the first aqueous liquid contacts the one or more ionic contaminants before the second aqueous liquid. And, in some embodiments, the agglomerating agent is provided as a layer of agglomerating agent downstream of the vessel.

In another aspect, described herein is a method of removing a contaminant from an aqueous mixture. The method comprises flowing a contaminated aqueous mixture comprising one or more ionic contaminants through a vessel that houses a carbon bed, wherein the one or more ionic contaminants are retained by the carbon bed. The method also comprises contacting the one or more ionic contaminants retained by the carbon bed with (a) a hydroxide and/or a peroxide, and (b) one or more cations selected from Ca²⁺, Mg²⁺, Zn²⁺, Sr²⁺, Al³⁺, B³⁺, and Fe³⁺. The (a) hydroxide and/or peroxide, and the (b) one or more cations are provided in a single aqueous liquid or in two or more separate aqueous liquids for contacting the one or more ionic contaminants. The method further comprises contacting the single aqueous liquid or two or more separate aqueous liquids with an agglomerating agent to form an aggregate contaminant phase comprising the one or more ionic contaminants after contacting the one or more ionic contaminants retained by the carbon bed with the (a) hydroxide and/or peroxide and the (b) one or more cations. The method also further comprises isolating the aggregate contaminant phase.

Other features and advantages of the invention will be apparent from the following detailed description, figures, and from the claims.

### BRIEF DESCRIPTION OF THE DRAWINGS

The following figures are provided by way of example and are not intended to limit the scope of the claimed invention.

FIG. 1 is an illustration of a capture system for removing contaminants from water according to an embodiment of the invention.

FIGS. 2A and 2B are a schematic of a capture system (2A) and regeneration system (2B) according to another embodiment of the invention.

FIGS. 3A and 3B are process diagrams of an integrated capture and regeneration system according to other embodiments of the invention.

FIG. 4 is a flow chart showing the steps of Example 1.

FIG. 5 shows the visual appearance of the carbon substrate of Example 1.

FIG. 6 is a chart showing PFNA absorption by a fresh carbon bed from a mixed contaminant sample.

FIG. 7 is a chart showing PFNA absorption by a regenerated carbon bed from a mixed contaminant sample.

FIG. 8 is a chart showing PFOA absorption by a fresh carbon bed from a mixed contaminant sample.

FIG. 9 is a chart showing PFOA absorption by a regenerated carbon bed from a mixed contaminant sample.

FIG. 10 is a chart showing PFOS absorption by a fresh carbon bed from a mixed contaminant sample.

FIG. 11 is a chart showing PFOS absorption by a regenerated carbon bed from a mixed contaminant sample.

FIG. 12 is a chart showing the concentration of PFOA in filtrate collected after flow through a carbon bed in a column.

FIG. 13 is a plot showing the PFOA concentration in effluent for fresh GAC and spent GAC according to Example 7.

FIG. 14 is a plot showing the PFOA concentration in effluent for pretreated GAC and unpretreated GAC according to Example 7.

FIG. 15 is a chart showing adsorption isotherms.

### DETAILED DESCRIPTION

### I. Definitions

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The terms, upper, lower, above, beneath, right, left, etc. may be used herein to describe the position of various elements with relation to other elements. These terms represent the position of elements in an example configuration. However, it will be apparent to one skilled in the art that the elements may be rotated in space without departing from the present disclosure and thus, these terms should not be used to limit the scope of the present disclosure.

As used herein, when an element is referred to as being “on,” “engaged to,” “connected to,” “attached to,” or “coupled to” another element, it may be directly on, engaged, connected, attached, or coupled to the other element, or intervening elements may be present. In contrast, when an element is referred to as being “directly on,” “directly engaged to,” “directly connected to,” “directly attached to,” or “directly coupled to” another element, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As used herein, the term “electrode” refers to a solid electric conductor that carries electric current to another element, such as a capture bed.

As used herein, the term “activated carbon” refers to a form of carbon processed to have small pores that increase the available surface area.

As used herein “polyfluoroalkyl ion” refers an ionic compound comprising an alkyl chain with multiple fluoro substitutions, which is optionally further substituted, such as with ether, alcohol, amine (including substituted amine), and carboxylic acid groups.

“Per- and polyfluoroalkyl substance” or “PFAS” includes but is not limited to the following substances: perfluorobutanoic acid, perfluoropentanoic acid, perfluorohexanoic acid (PFHxA), perfluoroheptanoic acid (PFHpA), perfluorooctanoic acid, perfluorononanoic acid (PFNA), perfluorodecanoic acid (PFDA), perfluoroundecanoic acid (PFUnA), perfluorododecanoic acid (PFDoA), perfluorotridecanoic acid, perfluorotetradecanoic acid, perfluorohexadecanoic acid, perfluorooctadecanoic acid, perfluorobutanesulfonic acid, perfluoropentanesulfonic acid, perfluorohexanesulfonic acid (PFHxS), perfluorooctanesulfonic acid, perfluorononanesulfonic acid, perfluorodecanesulfonic acid, perfluorododecanesulfonic acid, perfluorooctanesulfonamide, N-methylperfluoro-1-octanesulfonamide, N-ethylperfluoro-1-octanesulfonamide, 1H,1H,2H,2H-perfluorohexanesulfonic acid (4:2), 1H,1H,2H,2H-perfluorooctanesulfonic acid (6:2), 1H,1H,2H,2H-perfluorodecanesulfonic acid (8:2), 1H, 1H,2H,2H-perfluorododecanesulfonic acid (10:2), N-methyl perfluorooctanesulfonamidoacetic acid, N-ethyl perfluorooctanesulfonamidoacetic acid, 2-(N-methylperfluoro-1-octanesulfonamido)-ethanol, 2-(N-ethylperfluoro-1-octanesulfonamido)-ethanol, tetraluoro-2-(heptafluoropropoxy) propanoic acid (“GenX”), 4,8-dioxa-3H-perfluorononanoic acid, 11-chloroeicosafluoro-3-oxaundecane-1-sulfonic acid, or 9-chlorohexadecafluoro-2-oxanone-1-sulfonic acid. PFAS also includes partial fluorinations. The conjugate bases of these acids are examples of polyfluoroalkyl ions. Capturing PFAS includes capturing a conjugate base of a PFAS.

“PFOS” refers to perfluorooctanesulfonic acid. Capturing/releasing PFOS includes capturing/releasing its conjugate base, perfluorooctanesulfonate.

“PFOA” refers to perfluorooctanoic acid. Capturing/releasing PFOA includes capturing/releasing its conjugate base, perfluorooctanoate.

Systems and methods are described herein. It will be understood that embodiments of the invention described with reference to a system may be applicable to the methods described herein, and vice versa. For example, from a description of a particular carbon bed, such as an activated carbon bed, in a system, it will be understood that the activated carbon bed may be used in a method. Likewise, as another example, from a description of application of a particular voltage in a method, it will be understood that the system may be configured to apply the particular voltage.

### II. System for Regenerating a Capture Bed

In one aspect, provided herein is a system for regenerating a capture bed, or a “regeneration system.” Regenerating refers to removing ionic contaminant from the capture bed, i.e., contaminant that was bound to the capture bed during a water purification process. Systems and methods for capturing ionic contaminants on a capture bed, and thereby removing them from an aqueous mixture are described herein. As more ionic contaminants are bound to the capture bed the bed becomes less effective at removing the ionic contaminants. Eventually, the contaminants must be released from the capture bed or the capture bed itself must be replaced. Regenerating the capture bed in situ by releasing the bound ionic contaminants allows for continued use of the capture bed without costly replacement and environmentally harmful disposal of the spent capture bed.

The system for regenerating a capture bed includes a capture bed that is housed within a separation vessel. Optionally, the system may be an electrified system with an electrode in electrical contact with a capture bed that is housed within a separation vessel; a power source electrically coupled to, and configured to apply a voltage to the electrode; and a controller configured to control and modulate the voltage applied from the power source to the electrode. By enabling a voltage to be applied to an electrode in electrical communication with the capture bed, the regeneration system is able to apply voltage to the capture bed that drives the release of ionic contaminant from the capture bed.

In some embodiments, the electrode comprises graphite, titanium, stainless steel, cast iron, a conductive metal oxide, a conductive diamond, a titanium suboxide, titanium nitride, titanium carbide, titanium boride, a doped manganese oxide, or mixtures or composites thereof.

The system for regenerating a capture bed also includes a regeneration line fluidly coupled to the separation vessel and configured to introduce a flow of aqueous wash liquid to the separation vessel to wash ionic contaminant from the capture bed. The application of voltage to the electrode together with flow of wash liquid to the capture bed via the regeneration line drives the release of ionic contaminant from the capture bed, resulting in regeneration of the capture bed for further use. In some embodiments, the regeneration line is fluidly coupled to a regeneration line pump and/or a regeneration line valve to control the flow of wash liquid supplied to the separation vessel. In some embodiments, the regeneration system includes a flow controller (e.g., a PLC controller) to control the regeneration line pump and/or regeneration line valve.

In some embodiments, the regeneration system is a sub-system of an integrated capture and regeneration system. Such integrated systems are described below. Integrated systems can be installed at a site as a stand-alone system for providing purified water. Alternatively, the regeneration system may be an add-on system to an existing capture system. For example, there are existing systems for water purification with capture beds, e.g., carbon beds or ion exchange resin beds; the regeneration systems described herein may be installed as an add-on system to provide for in situ regeneration of an existing water purification system. In some embodiments, the regeneration system allows for continued use of the capture bed in the existing system by release, sequestration, and removal of the ionic contaminants in the capture bed.

The following embodiments describe an exemplary installation of an electrified regeneration system onto an existing capture system. In order to apply voltage to an existing capture system, the electrodes are installed by insertion into the existing capture bed, and hooked up to the power source controlled by the controller. A regeneration line is fitted onto the existing piping of the capture system (or directly onto the separation vessel) to add separate inlet and outlet flow of wash liquid into the separation vessel. Valves, e.g., control valves, are installed to control and switch the source of flow into the separation vessel between (1) an aqueous mixture to be purified (during a capture cycle) and (2) a wash liquid to regenerate the capture bed.

In some embodiments, the regeneration system includes concentration and removal of the ionic contaminant released from the capture bed. In some embodiments, a contaminant sequestration agent is employed that can more efficiently be removed from the system than removal of the capture bed. In some embodiments, the sequestration agent is more environmentally friendly to dispose of than disposal of a spent carbon bed or spent ion exchange resin bed (i.e., with bound contaminant).

In some embodiments, the sequestration agent is a counter ion in the wash liquid configured to bind to the ionic contaminant to form an aggregate contaminant phase. Suitable sequestration agents and counter ions are described below. In some embodiments, the system further includes a filter configured to remove the aggregate contaminant phase from the wash liquid. Since the aggregate contaminant phase is sparingly soluble to insoluble in the water phase, the precipitate tends to form a distinct solid or liquid phase that is large enough to either float or sink or be captured in a particulate filter. In some embodiments, a skimmer can be used to capture the aggregate contaminant phase.

In some embodiments, the regeneration system further comprises a regeneration vessel that houses a stationary ion source configured to bind the one or more ionic contaminants in the aqueous wash liquid, wherein the regeneration vessel is fluidly coupled to the separation vessel. In some embodiments, the stationary ion source comprises lime, e.g., a plurality of slaked lime pellets. In some embodiments, the stationary ion source is an alkaline metal coated surface where the surface electrostatically or by dispersion forces reversibly holds the alkaline element until a contaminant can form a precipitate. The contaminant is held at the surface until the surface binding is reversed (e.g., reversing polarity of electrodes).

In some embodiments, the regeneration system further comprises a sequestration agent vessel comprising a sequestration agent in a liquid media. In some embodiments, the regeneration system further comprises a mixing tank for mixing the sequestration agent with the wash liquid and optionally a settler apparatus for collecting solids precipitated from the liquid in the mixing tank. In some embodiments a filter is fluidly coupled to the mixing tank for filtering solids from the mixing tank, for example, solids that were not separated in the settler apparatus.

In some embodiments, the aqueous wash liquid comprises untreated contaminated aqueous mixture. In some embodiments, the aqueous wash liquid comprises a C₁₋₅ alcohol. In some embodiments, the aqueous wash liquid further comprises an antifreeze agent that lowers the freezing point of the aqueous wash liquid. In some embodiments, the antifreeze agent is selected from the group consisting of propylene glycol, polypropylene glycol, polyethylene glycol, glycerol, polyvinyl alcohol, carboxymethylcellulose, ribose, sucrose, glucose, rhamnose, xylose, fructose, raffinose, stachyose, low molecular weight hydroxyethyl starches, maltodextrin, cellodextrins, and combinations thereof. In some embodiments, the aqueous wash liquid comprises from about 0.01 wt % to about 20 wt % of the antifreeze agent (e.g., about 1 to about 10 wt % of the antifreeze agent, or about 0.01 to about 10 wt % of the antifreeze agent). In some embodiments, the freezing point of the aqueous wash liquid is below about −0.3° C. In some embodiments, the antifreeze agent encourages slush formation of the aqueous wash liquid at freezing temperatures.

In some embodiments, the aqueous wash liquid further comprises one or more additives for cleaning the capture bed of scale and/or inorganic precipitate. Inorganic precipitate may comprise, for example, iron or manganese. In some embodiments, the one or more additives are selected from the group consisting of acetic acid, propanoic acid, octanoic acid, glycolic acid, citric acid, ethylenediaminetetraacetic acid (EDTA), a water-soluble fatty acid, a salt of the aforementioned acids (e.g., a sodium or potassium salt), and any mixture thereof. In some embodiments, the acid is configured to solubilize inorganic precipitates or scale on the capture bed, e.g., at or near the leading edge of the capture bed. In some embodiments, the pH of the aqueous wash liquid with the additive(s) is from about 0 to about 6. In some embodiments, the pH of the aqueous wash liquid with the additive(s) is from about 3 to about 6. In some embodiments, the concentration of the additive(s) in the aqueous wash liquid is from about 0.01 wt % to about 15 wt %, or up to the limit of solubility of the acid in the wash liquid.

In some embodiments, the system further comprises a second wash liquid that can be used to rinse the capture bed before, after, or simultaneously with the aqueous wash liquid; the second wash liquid may be referred to as a “rinse liquid.” The rinse liquid may be introduced to the vessel via a rinse liquid line. The rinse liquid is an aqueous liquid comprising one or more additives for cleaning the capture bed of scale and/or inorganic precipitate. In some embodiments, the one or more additives are selected from the group consisting of acetic acid, propanoic acid, octanoic acid, glycolic acid, citric acid, ethylenediaminetetraacetic acid (EDTA), a water-soluble fatty acid, a salt of the aforementioned acids (e.g., a sodium or potassium salt), and any mixture thereof. In some embodiments, the pH of the rinse liquid is from about 3 to about 6. In some embodiments, the concentration of the additive(s) in the rinse liquid is from about 0.01 wt % to about 15 wt %, or up to the limit of solubility of the acid in the rinse liquid.

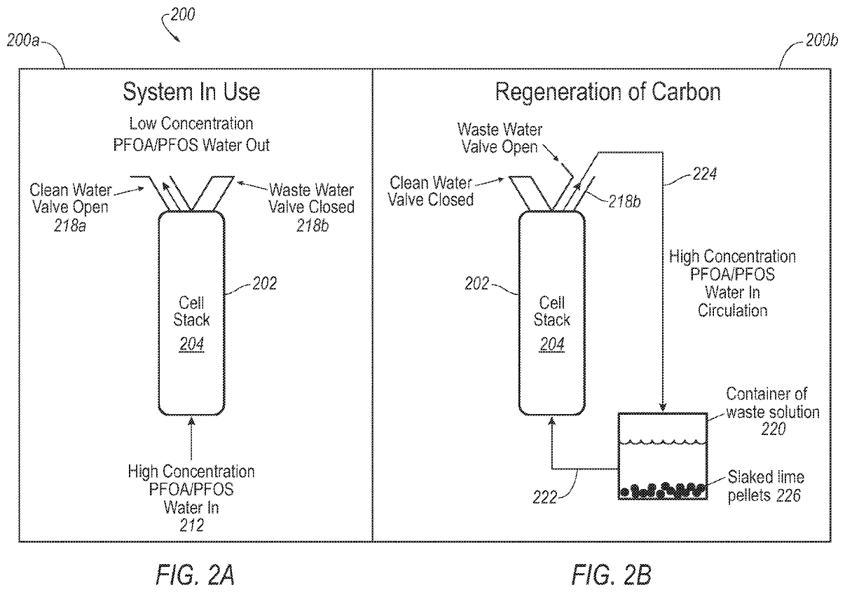

FIG. 2 is a schematic for an exemplary system 200 according to another embodiment of the present invention. FIG. 2A shows a capture system 200a in use for capturing contaminants, specifically PFOA and/or PFOS, from a water source, which is described in detail below. FIG. 2B shows a regeneration system 200b. The regeneration system as schematically shown in FIG. 2B may be part of an integrated capture and regeneration system or may be an add-on regeneration system. A regeneration vessel 220 comprising wash liquid (“container of waste solution”) is fluidly coupled via a regeneration line 222 to the separation vessel 202 that houses the capture bed, specifically a capture bed stack 204 (“cell stack”) and is configured to flow wash liquid through the separation vessel 202. A regeneration outlet line 224 is fluidly coupled to the opposite end of the separation vessel. A valve 218b controls flow out of the separation vessel via the regeneration outlet line 224. The regeneration outlet line 224 is fluidly coupled to the regeneration vessel 220 thus completing the circulation loop. The system 200b is configured to recirculate the wash liquid through the separation vessel 202 multiple times resulting in a wash liquid with high concentration of contaminant (e.g., PFOA/PFOS). The regeneration vessel 220 contains a stationary ion source 226, which are slaked lime pellets as shown in this embodiment. The slaked lime pellets 226 are configured to bind to the PFOA/PFOS in the regeneration vessel 220. Slaked lime pellets 226 can easily be removed from the system for disposal. Disposal of slaked lime pellets is more economical and environmentally friendly than disposal of an activated carbon bed or ion exchange resin bed.

### III. Method for Regenerating a Capture Bed

Another aspect provided herein is a method for regenerating a capture bed, or a “regeneration method.” The method of regenerating a capture bed includes providing a vessel that houses a capture bed having one or more ionic contaminants bound to the capture bed, and optionally an electrode in electrical contact with the capture bed. The vessel may be part of an integrated capture and regeneration system that includes a system for capturing a contaminant, as described below. Alternatively, the vessel may be part of an existing contaminant capture system (water purification system), wherein the regeneration method is performed on the existing vessel/capture system by installing a regeneration system (as described above) onto the existing vessel/capture system.

The method of regenerating a capture bed further includes flowing an aqueous wash liquid through the vessel and optionally applying a voltage to the electrode, such that the one or more ionic contaminants bound to the capture bed is released from the capture bed and washed from the bed via the aqueous wash liquid.

In some embodiments, the aqueous wash liquid is flowed into the separation vessel at a rate of from about 5 to about 400 liters per minute per square meter of capture bed to release bound ionic contaminant from the capture bed and wash the release ionic contaminant out of the capture bed.

In some embodiments, a voltage is applied to the electrode. In some embodiments, a voltage having a positive polarity of from about 0.01 V to about 1.5 V (e.g., about 0.01 V to about 1.2 V) is applied to the electrode in order to drive the release of the ionic contaminant from the capture bed to be washed away by the wash liquid. In some embodiments, a voltage having a negative polarity of from about −0.01 V to about −1.6 V is applied to the electrode in order to drive the release of the ionic contaminant. In some embodiments, an AC voltage is applied, optionally with a DC offset, to drive release of the ionic contaminant. In some embodiments, no voltage is applied.

In some embodiments, the wash liquid comprises a sequestration agent. In some embodiments, the sequestration agent is a counter ion. In some embodiments, the counter ion is a cation selected from Ca²⁺, Mg²⁺, Zn²⁺, Sr²⁺, Al³⁺, B³⁺, Al³⁺, or Fe³⁺. Cations are suitable for use in regenerating a capture bed with a bound anionic contaminant, such as perfluoroalkyl anions, or phosphate or borate contaminants. In some embodiments, the counter ion is Ca²⁺. In some embodiments, the counter ion is Al³⁺. In some embodiments, the counter ion is supplied to the wash liquid by addition of calcium hydroxide, calcium oxide, or calcium chloride to the wash liquid. In some embodiments, the wash liquid is basic and the source of Ca²⁺ is calcium hydroxide. In some embodiments, the wash liquid is acidic and the source of Ca²⁺ is calcium chloride. In some embodiments, the counter ion is supplied to the wash liquid by addition of aluminum hydroxide. In some embodiments, the counter ion is supplied to the wash liquid by addition of a mixture of aluminum hydroxide and sodium hydroxide. In some embodiments, the counter ion is supplied to the wash liquid by addition of NaAl(OH)₄ (sodium aluminate).

In some embodiments, the wash liquid, or a series of wash liquids, comprises one or more of the following: (a) a hydroxide and/or a peroxide, and (b) one or more cations selected from Ca²⁺, Mg²⁺, Zn²⁺, Sr²⁺, Al³⁺, B³⁺, and Fe³⁺. In some embodiments, the wash liquid (or one or more of the wash liquids) comprises a hydroxide and/or a peroxide. In some embodiments, the hydroxide and/or peroxide comprises sodium hydroxide. In some embodiments, the hydroxide and/or peroxide comprises hydrogen peroxide. In some embodiments, the hydroxide and/or peroxide comprises sodium peroxide. In some embodiments, the wash liquid (or one or more of the wash liquids) comprises one or more cations selected from Ca²⁺, Mg²⁺, Zn²⁺, Sr²⁺, Al³⁺, B³⁺, and Fe³⁺. In some embodiments, the one or more cations comprises Ca²⁺. In some embodiments, the Ca²⁺ is provided as calcium hydroxide. In some embodiments, the Ca²⁺ is provided as calcium chloride. In some embodiments, the one or more cations comprises Al³⁺. In some embodiments, the Al³⁺ is provided as aluminum sulfate. In some embodiments, the Al³⁺ is provided as sodium aluminate. In some embodiments, the Al³⁺ is provided as aluminum hydroxide (Al(OH)₃). In some embodiments, the aluminum hydroxide is used together with sodium hydroxide. In some embodiments, the (a) hydroxide and/or peroxide are provided in a first aqueous liquid; and the (b) one or more cations are provided in a second aqueous liquid. In some embodiments, the first aqueous liquid contacts the one or more ionic contaminants before the second aqueous liquid. In other embodiments, the second aqueous liquid contacts the one or more contaminants before the first aqueous liquid.

In some embodiments, the wash liquid, or a series of wash liquids, comprises one or more of the following: (a) sodium hydroxide and/or hydrogen peroxide, and (b) calcium hydroxide, aluminum hydroxide, and/or aluminum sulfate. In some embodiments, the (a) sodium hydroxide and/or hydrogen peroxide are provided in a first aqueous liquid for contacting the one or more ionic contaminants; and the (b) calcium hydroxide, aluminum hydroxide, and/or aluminum sulfate are provided in a second aqueous liquid for contacting the one or more ionic contaminants. In some embodiments, the first aqueous liquid contacts the ionic contaminants before the second aqueous liquid. In other embodiments, the second aqueous liquid contacts the one or more contaminants before the first aqueous liquid.

Without being bound by theory, it is believed that, among other possible benefits, the (a) hydroxide and/or peroxide facilitate breakdown of biofilm on the carbon bed. This breakdown of biofilm allows for efficient removal of ionic contaminants from the carbon bed.

In some embodiments, the wash liquid comprises a surfactant. The surfactant may be any surfactant described herein. In some embodiments, the wash liquid comprises an agglomerating agent. The agglomerating agent may be any agglomerating agent described herein.

When the (a) hydroxide and/or peroxide are provided in a first aqueous liquid and the (b) one or more cations are provided in a second aqueous liquid, the second aqueous liquid may further comprise a surfactant. In some embodiments, the second aqueous liquid further comprises an antifreeze agent. In some embodiments, the second aqueous liquid further comprises a surfactant and an antifreeze agent. And, in some embodiments, the second aqueous liquid further comprises a surfactant, an antifreeze agent, and an agglomerating agent. The surfactant, antifreeze agent, and agglomerating agent may be any surfactant, antifreeze agent, and the agglomerating agent described herein.

In some embodiments, the method of regeneration further comprises rinsing the carbon bed with an acidic aqueous solution by flowing the acidic aqueous solution through the vessel. In some embodiments, the acidic aqueous solution comprises hydrochloric acid, citric acid, sulfuric acid, nitric acid, or any combination thereof. For example, the acidic aqueous solution may comprise hydrochloric acid. In some embodiments, the acidic aqueous solution comprises sulfuric acid. In some embodiments, the acidic aqueous solution comprises an acid salt. For example, the acidic aqueous solution may comprise FeCl₂, FeCl₃, or a combination thereof.

In some embodiments, the method of regeneration further comprises rinsing the carbon bed with water by flowing water through the vessel. In some embodiments, the rinse water is substantially free of additives. In some embodiments, the acid rinse occurs after the rinse with the second aqueous liquid, and in some embodiments, occurs before the water rinse.

In some embodiments, the method of regeneration further comprises contacting the one or more ionic contaminants with a surfactant. The surfactant may be an anionic surfactant, a cationic surfactant, an amphoteric surfactant, a nonionic surfactant, or any combination thereof. In some embodiments, the surfactant is selected from fatty acids, sulphones, or phosphates. In some embodiments, the surfactant is selected from fatty acids, sulphones, phosphates, polyethers, sulfates, polyols, or any combination thereof. For example, the surfactant may comprise a fatty acid. In some embodiments, the surfactant comprises a sulphone. In other embodiments, the surfactant comprises a phosphate. In some embodiments, the surfactant comprises a polyether. In some embodiments, the surfactant comprises a sulfate (e.g., sodium dodecyl sulfate (SDS)). And, in some embodiments, the surfactant comprises a polyol.

Suitable polyethers include, by way of non-limiting example, polyethylene glycol (PEG), polypropylene glycol (PPG), polytetramethylene glycol (PTMG), or any combination thereof. In some embodiments, the polyether comprises PEG. The PEG may have an average molecular weight of less than about 1,000 g/mol, less than about 750 g/mol, less than about 600 g/mol, or less than about 550 g/mol. In some embodiments, the PEG is PEG 500, PEG 400, PEG 300, or any combination thereof. For example, the PEG may be PEG 300.

In some embodiments, the surfactant is selected from sodium dodecyl sulfate (SDS), sorbitan monolaurate, PEG, or any combination thereof.

In some embodiments, the surfactant contacts the one or more ionic contaminants before the hydroxide and/or peroxide contact the contaminants. In other embodiments, the surfactant contacts the one or more ionic contaminants after the hydroxide and/or peroxide contact the contaminants. And, in some embodiments, the surfactant contacts the one or more ionic contaminants simultaneously with the hydroxide and/or peroxide (e.g., the wash liquid comprises the surfactant and the hydroxide and/or peroxide).

In some embodiments, the surfactant contacts the one or more ionic contaminants before the (a) hydroxide and/or peroxide, and/or the (b) one or more cations contact the contaminants. In other embodiments, the surfactant contacts the one or more ionic contaminants after the (a) hydroxide and/or peroxide, and/or the (b) one or more cations contact the contaminants. And, in some embodiments, the surfactant contacts the one or more ionic contaminants simultaneously with the (a) hydroxide and/or peroxide, and/or the (b) one or more cations (e.g., the single aqueous liquid or two or more aqueous liquids comprise the surfactant).

In some embodiments, the method of regeneration further comprises contacting the one or more ionic contaminants with an agglomerating agent. The agglomerating agent may be any agglomerating agent described herein.

In some embodiments, the agglomerating agent contacts the one or more ionic contaminants before the hydroxide and/or peroxide contact the contaminants. In other embodiments, the agglomerating agent contacts the one or more ionic contaminants after the hydroxide and/or peroxide contact the contaminants. And, in some embodiments, the agglomerating agent contacts the one or more ionic contaminants simultaneously with the hydroxide and/or peroxide (e.g., the wash liquid comprises the agglomerating agent and the hydroxide and/or peroxide).

In some embodiments, the agglomerating agent contacts the one or more ionic contaminants before the (a) hydroxide and/or peroxide, and/or the (b) one or more cations contact the contaminants. In other embodiments, the agglomerating agent contacts the one or more ionic contaminants after the (a) hydroxide and/or peroxide, and/or the (b) one or more cations contact the contaminants. And, in some embodiments, the agglomerating agent contacts the one or more ionic contaminants simultaneously with the (a) hydroxide and/or peroxide, and/or the (b) one or more cations (e.g., the single aqueous liquid or two or more aqueous liquids comprise the agglomerating agent).

The steps of contacting/rinsing the bed with the wash liquid, or series of wash liquids, can be repeated, for example, repeated once, twice, or three or more times.

The steps of contacting/rinsing the bed, with the wash liquid, or series of wash liquids, may also be used as a pretreatment, i.e., may be performed prior to using the bed for capturing contaminants. The pretreatment may include contacting the carbon bed with sodium hydroxide and/or hydrogen peroxide. Additionally, or alternatively, the pretreatment may include contacting the carbon bed with one or more cations selected from Ca²⁺, Mg²⁺, Zn²⁺, Sr²⁺, Al³⁺, B³⁺, and Fe³⁺ (e.g., in the form of calcium hydroxide, calcium chloride, aluminum sulfate, aluminum hydroxide, or sodium aluminate). The pretreatment may also include rinsing with bed with an acid rinse (e.g., HCl) and/or with a water rinse. The various embodiments described for regenerating the carbon bed, as described herein, may be used as a pretreatment for the carbon bed, i.e., by performing the same treatment(s) prior to the bed being used to capture contaminants.

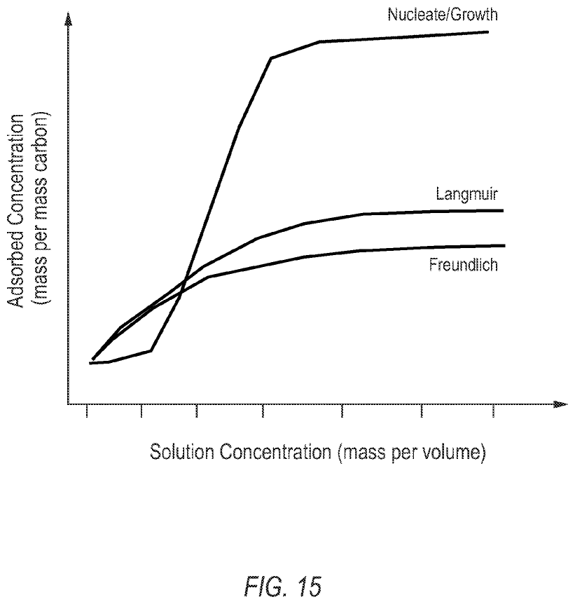

Polyfluorinated compounds do not appear to adsorb onto activated carbon by the traditional isotherm mechanism because they possess an extremely hydrophobic moiety. They appear to follow a nucleation, growth and aggregation mechanism where the hydrophobic moieties aggregate together. These domains appear as micelles adhered to the surface of the activated carbon at high solution concentrations. They are formed when first a few molecules of the perfluoro compounds find a site for adsorption on the activated carbon with some initial affinity. Subsequent perfluoro compounds then preferentially adsorb onto previously adsorbed perfluoro compounds. As the hydrophobic domains grow the effective surface area for adsorption increases until the micelles are too large to remain adhered to the surface of the carbon. This mechanism of adsorption gives an adsorbed amount versus solution concentration curve that looks like a traditional adsorption isotherm, Langmuir or Freundlich, but differing enough to be obvious when fitting experimental data (FIG. 15). The nucleation and growth model provides better fits to experimental data and better predicts the behavior of macroscopic columns. This description of the adsorption mechanism is useful in predicting exhaustion behavior of the activated carbon bed or column when treating natural water sources. There exists confusion in the literature for these compounds since most workers force a fit to an isotherm derived/surface coverage mechanism over small concentration ranges. However, the nucleation and growth model better fits and predicts behavior over many orders of magnitude of concentrations.

Without being bound by theory, the addition of di and trivalent metal salts to PFAS solutions appears to cause stabilization of these micelles. This is because most perfluoro compounds found in water also contain a hydrophilic moiety that usually forms an insoluble salt with the perfluoro compound. The effect of these insoluble salts is to increase the effective hydrophobicity of the perfluoro compound and stabilize both free micelle formation and micelle formation of surfaces. These stabilized micelles can reach tens of microns in size. These insoluble salts can also form with non-fluorinated compounds. These insoluble hydrophobic salts can also be used to stabilize the perfluoro compound micelles. Once these micelles form on the carbon, other organic compounds can become adsorbed into these micelle domains. These insoluble salts of perfluoro compounds, of fatty acids, of sulphonic acids, or of phosphoric acids are useful for pretreating the carbon surface to provide nucleation and stabilization to micelle formation on the surface of the carbon. These may be applied to any micelles of the metal salts and the precipitating compound with the carbon or may be applied to the carbon sequentially. Applying the metal salt first and then the compounds or the compound first and then the metal salt does not matter. Pretreating carbon in this way can boost the adsorption capacity of the carbon for perfluoro compounds found in natural or industrial water sources by up to 70 times (e.g., 2-10×). This pretreatment may also improve the adsorption kinetics, meaning treatment time may also be reduced.

In some embodiments, the pH of the aqueous wash liquid is modulated to cause the aggregate contaminant phase to precipitate from the aqueous wash liquid. For example, lime or other hydroxide can be added to the aqueous wash liquid to change the pH. Sodium hydroxide, carbon dioxide, bicarbonate, phosphoric acid, and sulfuric acid may also be used as pH modulating agents. In some embodiments, the pH is modulated distal to (i.e., downstream of) the capture bed. pH modulation may be accomplished with a lime wash of the column by bubbling carbon dioxide or adding bicarbonate in another tank upstream of the capture bed; this lowers the pH from the Ca(OH)₂ solution to a neutral or near neutral pH and improves the aggregate size of the precipitate by co-precipitating calcium carbonate with the perfluoroalkyl compounds. Alternatively, phosphoric acid and sulfuric acid may also be introduced to form salts with calcium and act as neutralizing agents. In some embodiments, the wash liquid comprises sodium hydroxide.

In some embodiments, the counter ion is an anion selected from a phosphate, a sulfate, or a borate. Anions are suitable for use in regenerating a capture bed with a bound cationic contaminant, such as perfluoroalkyl cations. In some embodiments the counter ion is supplied to the wash liquid by addition of calcium phosphate, calcium borate, calcium sulphate, magnesium phosphate, magnesium borate, or magnesium sulphate to the wash liquid.

In some cases, perfluoroalkyl compounds may be nonionic and must first be partially decomposed before they can be released using the counter ion. In such instances, the regeneration method further comprises partially decomposing the nonionic perfluoroalkyl compound(s), such as by chemical, photochemical, electrochemical decomposition or by application of DC or AC electrical discharge.

In some embodiments, upon flowing the wash liquid comprising the sequestration agent through the separation vessel, the sequestration agent and the released ionic contaminant form an aggregate contaminant phase. In some embodiments, the aggregate contaminant phase separates from the aqueous wash liquid by precipitation. In other embodiments, the aggregate contaminant phase forms a foam. In other embodiments, the aggregate contaminant phase forms a dispersed phase within the aqueous wash liquid. In other embodiments, the aggregate contaminant phase is formed by micelle formation, agglomeration, flocculation, flotation, or breaking an emulsion.

In some embodiments, the aggregate contaminant phase is isolated from the wash liquid. In some embodiments, isolation comprises filtration, nano-filtration, or sedimentation.

In some embodiments, the aqueous wash liquid is at least substantially saturated with the ionic contaminant upon exiting the capture bed.

In some embodiments, the regeneration method comprises adding a sequestration agent to the wash liquid. In some embodiments, a sequestration agent vessel is provided containing the sequestration agent in liquid media (e.g., aqueous media) and the sequestration agent is flowed from the sequestration agent vessel to be added to the wash liquid. The flow may be controlled by a pump and/or valve. In some embodiments, the sequestration agent is mixed with the wash liquid, for example in a mixing tank. In some embodiments, the wash liquid mixed with the sequestration agent is wash liquid that is substantially saturated with the ionic contaminant.

In some embodiments, a rinse liquid comprising additive(s), as described above, is flowed through the vessel and the capture bed. The rinse liquid may be used before, after, or simultaneously with the aqueous wash liquid. In some embodiments, the method further comprises removing, and optionally solubilizing, inorganic precipitates or scale on the capture bed, e.g., at or near the leading edge of the capture bed.

In some embodiments, the regeneration method further comprises contacting the released ionic contaminant in the aqueous wash liquid with a stationary ion source, such that the ionic contaminant is bound to the stationary ion source forming an aggregate contaminant phase.

In some embodiments, the regeneration method further comprises contacting the aqueous wash liquid comprising the ionic contaminant (e.g., the aqueous wash liquid after flowing through the separation vessel) with an agglomerating agent. The agglomerating agent facilitates and/or promotes agglomeration of the ionic contaminant alone or in combination with the sequestration agent. For example, the regeneration method may further comprise contacting the wash liquid comprising the ionic contaminant with an agglomerating agent to form the aggregate contaminant phase. In some embodiments, the aggregate contaminant phase separates from the aqueous wash liquid by precipitation. In other embodiments, the aggregate contaminant phase forms a foam. In other embodiments, the aggregate contaminant phase forms a dispersed phase within the aqueous wash liquid.

The agglomerating agent may be any agent suitable for facilitating and/or promoting agglomeration of the ionic contaminant alone or in combination with the sequestration agent. In some embodiments, the agglomerating agent comprises an oil, a terpene, a fatty acid ester, or any combination thereof. For example, the oil may be selected from coconut oil, corn oil, cottonseed oil, olive oil, palm oil, peanut oil, rapeseed oil (e.g., canola oil), safflower oil, sesame oil, soybean oil, sunflower oil, or any combination thereof. In some embodiments, the oil comprises safflower oil, rapeseed oil, or any combination thereof. In some embodiments, the terpene is selected from myrcene, menthol, limonene, carvone, hinokitiol, linalool, or any combination thereof. In some embodiments, the fatty acid ester is ethyl octanoate. And, in some embodiments, the agglomerating agent is selected from safflower oil, rapeseed oil, limonene, ethyl octanoate, or any combination thereof.

In some embodiments, the regeneration method further comprises removal of the aggregate contaminant phase. In some embodiments, removal of the aggregate contaminant phase comprises filtering the aggregate contaminant phase from the wash liquid.

In some embodiments, the regeneration method further comprises disposal of the removed aggregate contaminant phase, e.g., to a landfill. The aggregate contaminant phase may also be destroyed, e.g., by calcination, thermal decomposition, or vitrification. In some embodiments, the regeneration method further comprises electrochemical oxidation of the wash liquid.

In some embodiments, the regeneration method further comprises pre-oxidizing the ionic contaminant comprising converting alcohol groups of the ionic contaminant to carboxylic acid groups by chemical or electrochemical means.

In some embodiments, the ionic contaminant comprises an organic end with an ionic moiety. In some embodiments, the ionic contaminant is selected from the group consisting of a polyfluoroalkyl ion, a borate, a phosphate, a polyphosphate, a sulfate, an organic acid, a fatty acid, a humic substance, a shortchain PFAS, a water-soluble medication, a detergent, a water-soluble insecticide, a water-soluble fungicide, a water-soluble germicide, and any combination thereof. In some embodiments, the ionic contaminant is a polyfluoroalkyl ion. In some embodiments, the polyfluoroalkyl ion is perfluorooctanesulfonate or perfluorooctanoate. Perfluorooctanesulfonate is the conjugate base of perfluorooctanesulfonic acid (PFOS). Perfluorooctanoate is the conjugate base of perfluorooctanoic acid (PFOA). In some embodiments, the polyfluoroalkyl ion is perfluorobutanesulfonate or perfluorobutanoate. Perfluorobutanesulfonate is the conjugate base of perfluorobutanesulfonic acid (PFBS). Perfluorobutanoate is the conjugate base of perfluorobutanoic acid (PFBA).

The system of FIG. 2B can also be described in terms of a regeneration method of which it illustrates. Wash liquid (“waste solution”) is flowed to a separation vessel that houses a capture bed (“cell stack”) and flows through the vessel. Ionic contaminants bound to the cell stack are released as wash liquid flows through the vessel and voltage is applied (not shown) to the cell stack. A valve (“waste water valve”) is opened to direct flow of wash liquid with released ionic contaminant (PFOA and/or PFOS) to a regeneration vessel (“container of waste solution”) via a regeneration outlet line. A stationary ion source (slaked lime pellets in this embodiment) binds the PFOA/PFOS. The slaked lime pellets with bound PFOA/PFOS can be removed from the system and disposed of.

In one aspect, the present invention provides a method of regenerating a carbon bed. The method comprises providing a vessel that houses a carbon bed having one or more ionic contaminants retained thereon or therein. The method also comprises contacting the one or more ionic contaminants retained by the carbon bed with (a) a hydroxide and/or a peroxide, and (b) one or more cations selected from Ca²⁺, Mg²⁺, Zn²⁺, Sr²⁺, Al³⁺, B³⁺, and Fe³⁺. The (a) hydroxide and/or peroxide, and the (b) one or more cations are provided in a single aqueous liquid or in two or more separate aqueous liquids for contacting the one or more ionic contaminants. The method further comprises contacting the one or more ionic contaminants with an agglomerating agent. The method also further comprises forming an aggregate contaminant phase comprising the one or more ionic contaminants. The method also further comprises isolating the aggregate contaminant phase.

In some embodiments, the agglomerating agent contacts the one or more ionic contaminants before the (a) hydroxide and/or peroxide, and/or the (b) one or more cations contact the contaminants. In other embodiments, the agglomerating agent contacts the one or more ionic contaminants after the (a) hydroxide and/or peroxide, and/or the (b) one or more cations contact the contaminants. And, in some embodiments, the agglomerating agent contacts the one or more ionic contaminants simultaneously with the (a) hydroxide and/or peroxide, and/or the (b) one or more cations (e.g., the single aqueous liquid or two or more aqueous liquids comprise the agglomerating agent).

In some embodiments, the agglomerating agent comprises an oil, a terpene, a fatty acid ester, or any combination thereof. For example, the oil may be selected from coconut oil, corn oil, cottonseed oil, olive oil, palm oil, peanut oil, rapeseed oil (e.g., canola oil), safflower oil, sesame oil, soybean oil, sunflower oil, or any combination thereof. In some embodiments, the oil comprises safflower oil, rapeseed oil, or any combination thereof. In some embodiments, the terpene is selected from myrcene, menthol, limonene, carvone, hinokitiol, linalool, or any combination thereof. In some embodiments, the fatty acid ester is ethyl octanoate. And, in some embodiments, the agglomerating agent is selected from safflower oil, rapeseed oil, limonene, ethyl octanoate, or any combination thereof.

### IV. System for Capturing a Contaminant

Another aspect provided herein is a system for capturing an ionic contaminant, or a “capture system.” The capture system includes a separation vessel that houses a capture bed configured to capture ionic contaminants in an aqueous mixture flowed through the separation vessel. In some embodiments, the system also provides for regeneration of the capture bed as an integrated capture and regeneration system, or an “integrated system.” The integrated system may include any of the features of a regeneration system and/or capture system as described herein.

The capture system includes: a separation vessel and disposed therein a capture bed; and an intake line fluidly coupled to the vessel and configured to introduce a flow of a contaminated aqueous mixture to the vessel such that one or more ionic contaminants in the contaminated aqueous mixture binds to the capture bed; and optionally further includes an electrode in electrical contact with the capture bed, a power source electrically coupled to, and configured to apply a voltage to, the electrode that is in electrical contact with the capture bed, and a controller configured to control and modulate the voltage applied from the power source to the electrode.

The integrated capture and regeneration system includes a capture system and further includes a regeneration line fluidly coupled to the vessel and configured to introduce a flow of aqueous wash liquid to the vessel to wash ionic contaminant from the capture bed.

In some embodiments, the capture system further includes a pump fluidly coupled to the intake line and configured to pump the contaminated aqueous mixture into the separation vessel. In some embodiments, the capture system further includes a valve fluidly coupled to the intake line and configured to control the flow of the contaminated aqueous mixture into the separation vessel.

In some embodiments, the system is a non-electrified system.

In some embodiments, the system is an electrified system with an electrode, power source, and controller as described herein. In some embodiments, the controller is configured to reduce or reverse the current applied from the power source. In some embodiments, the controller is further configured to reduce the voltage applied to the electrode, reverse the polarity of the voltage applied to the electrode, terminate the voltage applied to the electrode, or any combination thereof. As described in the methods below, the power source is configured to apply a first voltage to the electrode during flow of contaminated aqueous mixture to capture bed (during a capture cycle). During flow of wash liquid to the capture bed (during a regeneration cycle), terminating, reducing or reversing the current helps to drive the release of the bound contaminant from the capture bed.

In some embodiments, the capture bed (e.g., activated carbon bed) is pretreated to improve its performance. Specifically, the pretreatment may include one or more (e.g., two or more, three or more, or all four) of the following: (a) contacting the carbon bed with a hydroxide and/or a peroxide, (b) contacting the carbon bed with one or more cations selected from Ca²⁺, Mg²⁺, Zn²⁺, Sr²⁺, Al³⁺, B³⁺, and Fe³⁺, (c) rinsing the carbon bed with an acidic aqueous solution, and (d) rinsing the carbon bed with water. In some embodiments, pretreating the bed comprises treating the bed according to a regeneration process as described herein prior to the first use of the bed to capture contaminants.

In some embodiments, the capture bed (e.g., activated carbon bed) is surface-modified with functional groups selected from the group consisting of an acid, a hydroxide, a chloride, a bromide, a fluoride, an ether, an epoxide, a quinone, a ketone, an aldehyde, a pyrrole, a thiophene, and any combination thereof.

In some embodiments, the capture bed is at least partially conductive. In some embodiments, the capture bed is porous. In some embodiments, the capture bed is an activated carbon bed. In some embodiments, the capture bed is an ion exchange resin bed. In some embodiments, the capture bed is a composite of activated carbon and ion exchange resin. In some embodiments, the capture bed is an activated carbon metal oxide composite. In some embodiments, the capture bed is a FILTRASORB® activated carbon bed from Calgon Carbon. In some embodiments, the capture bed comprises BLACK PEARLS® 2000 (activated graphite) from Cabot corporation. In some embodiments, the capture bed comprises PBX51 (activated graphite) from Cabot corporation. In some embodiments, the carbon bed comprises sintered carbon. In some embodiments, the carbon bed comprises F400 granulated activated carbon from Calgon Carbon.

In some embodiments, the capture bed comprises powder, granules, beads, pellets, cloths, felts, nonwoven fabrics, or composites comprising a material selected from carbon, nitrogen-doped carbon, silicon-doped carbon, boron-doped carbon, charcoal, graphite, biochar, coke, carbon black, or any combination thereof. In some embodiments, the capture bed comprises activated charcoal powder, granules, pellets, beads, or any combination thereof.

In some embodiments, the capture bed comprises activated carbon having an average surface area of from about 100 m²/g to about 2000 m²/g. In some embodiments, the capture bed has a conductivity of from about 0.01 S/cm to about 100 S/cm. In some embodiments, the capture bed has a porosity of from about 30% to about 95%.

In some embodiments, the capture bed is surface-modified with functional groups selected from the group consisting of an acid, a hydroxide, a chloride, a bromide, a fluoride, an ether, an epoxide, a quinone, a ketone, an aldehyde, a pyrrole, a thiophene, and any combination thereof. In some embodiments, the capture bed has an ionic complexing species bound to it. In some embodiments, the ionic complexing species is Ca²⁺, Mg²⁺, Al³⁺, phosphate, borate, or silicate. In some embodiments, the ionic complexing species is an alkaline ion mixed with fatty acid or wax.

In some embodiments, the capture bed further comprises a binder dispersed in the capture bed. In some embodiments, the binder comprises a wax, a starch, a sugar, a polysaccharide, or any combination thereof. In some embodiments, the wax is a polyethylene wax. In some embodiments, the wax is carnauba wax.

In some embodiments, the capture bed is disposed longitudinally along the flow axis of the separation vessel such that the contaminated aqueous mixture flows by the capture bed. In other embodiments, the capture bed is disposed laterally across the separation vessel such that the water flows through the capture bed.

In some embodiments, the capture bed is adjacent to a separator. In some embodiments, the capture bed is wrapped in a separator, enclosed within a separator, or sandwiched between two separators.

In some embodiments, the capture system further comprises a second separation vessel that houses a second capture bed and a second electrode in electrical contact with the second capture bed. In some embodiments, the power source or a second power source is configured to apply a voltage to the second electrode that is in electrical contact with the second capture bed.

In some embodiments, the separation vessel further houses a second capture bed and a second electrode in electrical contact with the second capture bed. In some embodiments, the second capture bed is adjacent to the first capture bed with a separator disposed between the first and second capture beds. In some embodiments, the separator is disposed around the first and second capture beds in a Z-fold, S-fold, or C-fold arrangement. In some embodiments, the separator is disposed around one or more capture beds in a spiral wound or jelly roll configuration. In some embodiments, the power source is configured to apply a positive voltage to one of the first and second capture beds, and a negative voltage to the other of the first and second capture beds.

In some embodiments, the separation vessel comprises a stack comprising a plurality of capture beds. In some embodiments, the plurality of capture beds in the stack are separated from each other by one or more separators. In some embodiments, the plurality of capture beds are in electrical contact with the first or second electrode.

In some embodiments, the power source is configured to apply a positive voltage to the first electrode, wherein the first electrode is in electrical contact with a first plurality of capture beds, and wherein the power source is configured to apply a negative voltage to the second electrode, wherein the second electrode is in electrical contact with a second plurality of capture beds.

In some embodiments, the first plurality of capture beds are stacked in an alternating fashion with the second plurality of capture beds.

In some embodiments, the vessel is a pipe, column, or tank. The capture bed (e.g., carbon bed) may have any shape.

In some embodiments, the separator comprises a porous plastic. In some embodiments, the porous plastic is a plastic mesh. In some embodiments, the separator comprises an inert material. Suitable materials for the separator include nylon, polyamide, polypropylene, and HDPE.

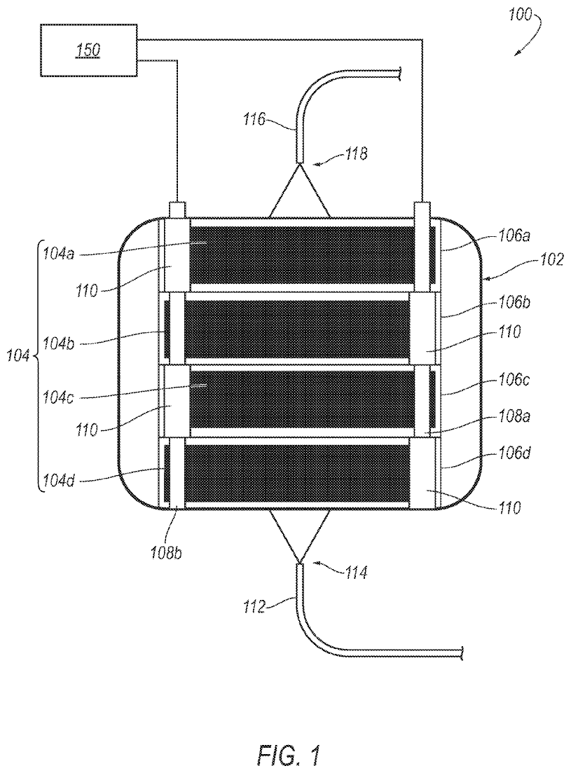

FIG. 1 illustrates an exemplary capture system according to an embodiment of the present invention. In this embodiment, a separation vessel or column 102 (e.g., PVC pipe) houses a stack 104 of carbon powder capture beds 104a-d. The stack 104 is arranged with each carbon powder capture bed 104a-d wrapped in a non-woven separator 106a-d. Stacks can be added, and the column 102 lengthened, to fit the desired amount of carbon. The stack 104 is configured with the wrapped carbon powder capture beds 104a-d disposed laterally across the vessel 102 such that flow through the vessel 102 will flow through each capture bed 104a-d of the stack 104. Electrodes 108 (or “current collectors”) made of graphite filled polymer are in electrical contact with the carbon powder capture beds 104a-d. The electrodes 108 are electrically coupled to a power source 150 A first electrode 108a is inserted longitudinally through the stack 104 and is in electrical contact with a first 104a and third 104c capture bed of the stack, but is electrically insulated from a second 104b and fourth 104d capture bed of the stack. Non-conductive tape 110 is wrapped around a portion of the first electrode 108a in its electrically insulated areas in the second and fourth capture bed. A second electrode 108b is inserted longitudinally (and separated from the first electrode 108a) through the stack 104 and is in electrical contact with the second 104b and fourth 104d capture bed of the stack, but is electrically insulated from the first 104a and third 104c capture bed. Non-conductive tape 110 is wrapped around a portion of the second electrode 108b in its electrically insulated areas in the first 104a and third 104c capture bed. An intake line 112 is fluidly coupled to a first end of the separation vessel 102 and an outlet line 116 is fluidly coupled to a second end of the separation vessel 102. The inlet line 112 includes an inlet valve 114. The outlet line 116 includes an outlet valve 118.

FIG. 2 is a schematic for exemplary system 200 according to another embodiment of the present invention. FIG. 2A shows a capture system 200a in use for capturing contaminants, specifically PFOA or PFOS, from a water source. An intake line 212 is fluidly coupled to a vessel 202 that houses a cell stack 204 and configured to supply water in need of treatment due to high concentration of PFOA and/or PFOS (e.g., having levels PFOA and/or PFOS above the upper limit as defined by EPA or other regulatory body) into the vessel 202. The cell stack 204 comprises capture beds in a stack, optionally with separator between the beds. An outlet has valves 218a, 218b for a clean water outlet and a waste water (i.e. wash liquid) outlet. FIG. 2B shows a regeneration system 200b as described above. The regeneration system of FIG. 2B may be installed together with the system of FIG. 2A as part of an integrated system.

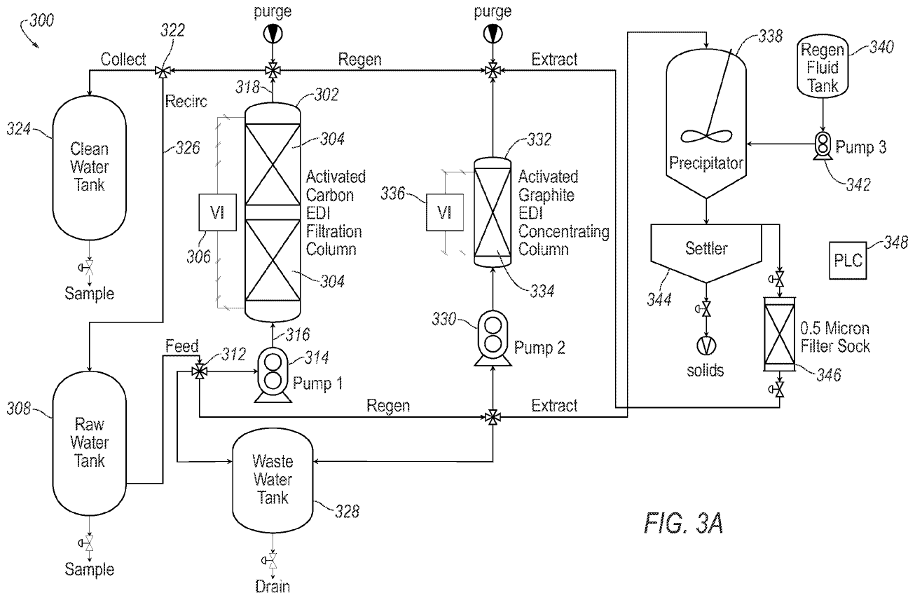

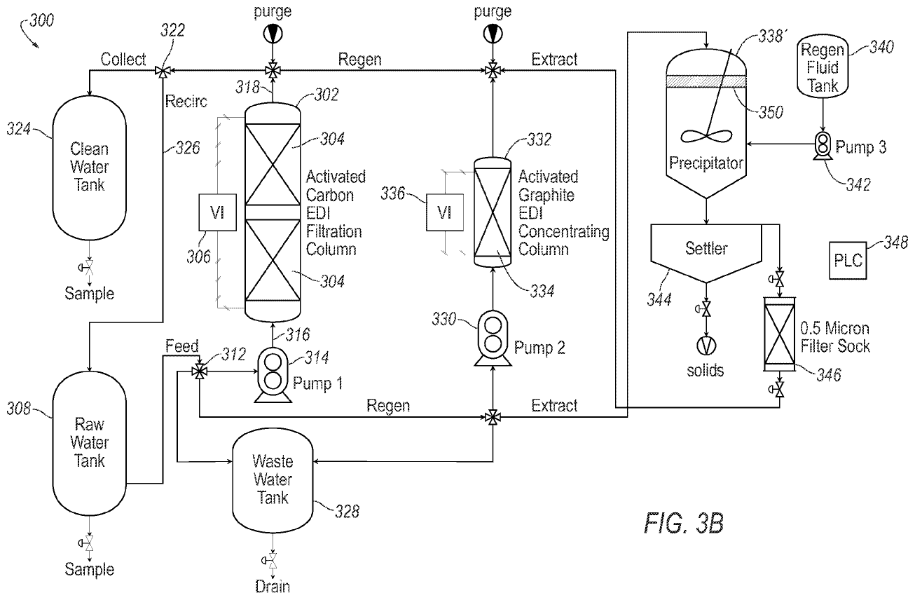

FIG. 3A is a process diagram for an exemplary integrated system 300 according to another embodiment of the present invention. In this embodiment, a raw water tank 308 contains the contaminated aqueous mixture in need of ionic contaminant removal. The raw water tank 308 is fluidly coupled to a pump 314 (“pump 1”) with an intervening valve 312 to control flow. Pump 1 314 is fluidly coupled to the inlet 316 of a separation vessel 302 (e.g., an activated carbon EDI filtration column) that houses activated carbon capture beds 304. A voltage/current source 306 is electrically coupled to the capture beds 304 of the separation vessel 302. The outlet 318 of the column 302 is fluidly coupled to a clean water tank 324 with an intervening valve 322. The intervening valve 322 is also fluidly coupled to the raw water tank 308 via recirculation line 326 providing for optional recirculation of the liquid for one or more additional cycles of contaminant removal. The raw water tank 308 is also fluidly coupled to another pump 330 (“pump 2”) via the same intervening valve 312 that controls flow into pump 1 314. Pump 2 330 is fluidly coupled to a second separation vessel 332 (an activated graphite EDI concentrating column) that houses an activated graphite capture bed 334. A voltage/current 336 source is electrically coupled to the activated graphite bed 334. The second separation vessel 332 is fluidly coupled to the clean water tank 308 and to the recirculation valve 322.

Still referring to FIG. 3A, a regeneration vessel 328 (waste water tank) containing wash liquid is fluidly coupled to both Pump 1 314 and Pump 2 330 and both separation vessels 302, 332. The wash liquid upon flowing through the capture beds 304 and/or 334 can be referred to as extract and is fluidly coupled to a precipitator 338. The precipitator 338 is also fluidly coupled to a regeneration fluid tank 340 via another pump 342 (“Pump 3”). The regeneration fluid tank 340 contains a counter ion in a liquid media. The precipitator 338 is fluidly coupled to a settler 344 for removing precipitated solids from the extract upon mixing with the counter ion. The settler 344 is also fluidly coupled to a filter 346 for further removal of solids from the liquid phase exiting the settler. The system 300 can be controlled by a PLC controller 348.

FIG. 3B is substantially similar to FIG. 3A except that a layer of agglomerating agent 350 is included in the precipitator 338′. In this manner, the aqueous wash fluid comprising the ionic contaminant may flow from one or both separation vessels 302, 332, to the precipitator 338′ such that the aqueous wash fluid is brought into contact with the agglomerating agent thereby facilitating and/or promoting agglomeration of the ionic contaminant alone or in combination with the sequestration agent. It will be appreciated that the layer of agglomerating agent 350 may be positioned in any suitable location downstream of the separation vessels 302, 332 to facilitate and/or promote agglomeration of the ionic contaminant prior to the aqueous wash fluid being recycled through the separation vessels 302, 332.

### V. Method for Capturing a Contaminant

Another aspect provided herein is a method for capturing an ionic contaminant, or a “capture method.” The capture method includes flowing an aqueous mixture comprising one or more ionic contaminants through a separation vessel that houses a capture bed in order to bind the one or more ionic contaminants to the capture bed, thereby removing the one or more ionic contaminants from the aqueous mixture. In some embodiments, the method includes regeneration of the capture bed as part of an integrated capture and regeneration method, or an “integrated method.”

In some embodiments, the capture method further includes pretreatment of the capture bed prior to first capture. The pretreatment may include contacting (e.g., rinsing) the capture bed according to regeneration processes described in any embodiments herein. For example, the method may comprise one or more (e.g., two or more, three or more, or all four) of the following: (a) contacting the carbon bed with a hydroxide and/or a peroxide, (b) contacting the carbon bed with one or more cations selected from Ca²⁺, Mg²⁺, Zn²⁺, Sr²⁺, Al³⁺, B³⁺, and Fe³⁺, (c) rinsing the carbon bed with an acidic aqueous solution, and (d) rinsing the carbon bed with water.

In some embodiments, the capture method further includes applying a voltage to the electrode that is in electrical contact with the capture bed, such that the one or more ionic contaminants is bound to the capture bed. The applied voltage enhances the binding of the one or more ionic contaminants to the capture bed. Methods with application of voltage are referred to as electrified methods.

The integrated method further includes a regeneration cycle comprising flowing an aqueous wash liquid through the separation vessel and optionally, in electrified methods, modulating the voltage applied to the electrode, such that the one or more ionic contaminants bound to the capture bed is released from the capture bed and is washed from the capture bed via the aqueous wash liquid. The modulated voltage helps to drive the release of the bound ionic contaminant from the capture bed. The integrated method, specifically the regeneration cycle thereof, may include any of the steps and features of the regeneration method described above.

In some embodiments, applying the voltage to the electrode comprises running an electrical current to the electrode, and modulating the voltage comprises reducing or reversing the electrical current running to the electrode. In some embodiments, the voltage applied to the electrode during capture of contaminants has a positive polarity from about 0.01 V to about 2.2 V. In some embodiments, the voltage applied to the electrode during capture of contaminants has a positive polarity from about 0.01 V to about 1.6 V. In some embodiments, modulating the voltage to release the ionic contaminant comprises reducing the electric current to generate a modulated voltage having a positive polarity of from about 0.01 V to about 1.5 V (e.g., about 0.01 V to about 1.2 V). In some embodiments, modulating the voltage to release the ionic contaminant comprises reversing the electric current to generate a modulated voltage having a negative polarity of from about −0.01 V to about −2.2V or from about −0.01 V to about −1.6 V. In some embodiments, modulating the voltage to release the ionic contaminant comprises applying an AC voltage optionally with a DC offset.

In some embodiments, the contaminated aqueous mixture is flowed into the vessel at a rate from about 5 to about 400 liters per minute per square meter of capture bed. In some embodiments, the contaminated aqueous mixture is flowed into the vessel at a rate from about 80 to about 240 liters per minute per square meter of capture bed. In some embodiments, the contaminated aqueous mixture is flowed into the vessel at a rate from about 0.01 to about 10 liters per minute per kilogram of capture bed. In some embodiments, the capture bed has a mass of from about 4,000 to about 10,000 kilograms. In some embodiments, the pressure drop across the capture bed is from about 1 psi to about 200 psi.

In some embodiments, the aqueous wash liquid is flowed into the vessel at a rate from about 5 to about 400 liters per minute per square meter of capture bed. In some embodiments, the aqueous wash liquid is flowed into the vessel at a rate from about 80 to about 240 liters per minute per square meter of capture bed. In some embodiments, the aqueous wash liquid is flowed into the vessel at a rate from about 0.01 to about 10 liters per minute per kilogram of capture bed.

In some embodiments, the capture method further comprises binding an ionic complexing species to the capture bed prior to flowing the contaminated aqueous mixture through the vessel, such that upon flowing the contaminated aqueous mixture through the vessel, the ionic contaminant binds to the capture bed by forming a complex with the ionic complexing species wherein the complex is bound to the capture bed. In some embodiments, the ionic complexing species is Ca²⁺, Mg²⁺, phosphate, borate, or silicate. In some embodiments, the ionic complexing species is an alkaline ion mixed with fatty acid or wax.

In some embodiments, the capture bed is situated in the vessel such that the contaminated aqueous mixture flows by the capture bed. In some embodiments, the capture bed is situated in the vessel such that the contaminated aqueous mixture flows through the capture bed.

In some embodiments, the capture method further includes flowing the contaminated aqueous mixture through a second vessel that houses a second capture bed and a second electrode in electrical contact with the second capture bed and applying a voltage to the second electrode that is in electrical contact with the second capture bed.

In some embodiments, the vessel further houses a second capture bed and a second electrode in electrical contact with the second capture bed and the capture method further includes applying a voltage to the second electrode that is in electrical contact with the second capture bed. In some embodiments, the second capture bed is adjacent to the first capture bed with a separator disposed between the first and second capture beds. In some embodiments, a positive voltage is applied to one of the first and second capture beds, and a negative voltage is applied to the other of the first and second capture beds.

In some embodiments, the vessel comprises a capture bed stack comprising a plurality of capture beds. In some embodiments, the plurality of capture beds are separated from each other by one or more separators. In some embodiments, the plurality of capture beds are in electrical contact with the first or second electrode. In some embodiments, the capture method further comprises applying a positive voltage to the first electrode, wherein the first electrode is in electrical contact with a first plurality of capture beds; and applying a negative voltage to the second electrode, wherein the second electrode is in electrical contact with a second plurality of capture beds. In some embodiments, the first plurality of capture beds are stacked in an alternating fashion with the second plurality of capture beds.

In some embodiments, the capture method further comprises surface-modifying the capture bed with a functional group selected from the group consisting of an acid, a hydroxide, a chloride, a bromide, a fluoride, an ether, an epoxide, a quinone, a ketone, an aldehyde, a pyrrole, a thiophene, and any combination thereof.

In some embodiments, the ionic contaminant comprises an organic end with an ionic moiety. In some embodiments, the ionic contaminant is selected from the group consisting of a polyfluoroalkyl ion, a borate, a phosphate, a polyphosphate, a sulfate, an organic acid, a fatty acid, a humic substance, a shortchain PFAS, a water-soluble medication, a detergent, a water-soluble insecticide, a water-soluble fungicide, a water-soluble germicide, and any combination thereof. In some embodiments, the ionic contaminant is a polyfluoroalkyl ion. In some embodiments, the polyfluoroalkyl ion is perfluorooctanesulfonate or perfluorooctanoate.

In some embodiments, the contaminated aqueous mixture further comprises inorganic contaminants. In some embodiments, the inorganic contaminants include iron or manganese. In some embodiments, the inorganic contaminants in the contaminated aqueous mixture result in scale formation or inorganic precipitate formation on the capture bed; the scale or inorganic precipitate can be removed by the use of one or more additives in the wash liquid or in a separate rinse liquid. In some embodiments, the use of the additive(s) reduces the amount of time needed to regenerate the capture bed and/or reduces the volume of wash liquid needed to regenerate the capture bed.

The system of FIG. 2A can also be described in terms of a capture method of which it illustrates. Water comprising a high concentration of PFOA and/or PFOS contaminant is flowed into a separation vessel that houses a plurality of capture beds in a stack (“cell stack”). As the water flows through the cell stack the PFOA and/or PFOS ionic contaminant is bound to the capture bed. With the bound contaminant removed from the flow of water through the separation vessel, water with a low concentration of PFOA and/or PFOS flows out of the separation vessel via an outlet line. Flow through the outlet line is controlled by a valve, which is open during the capture cycle (“system in use”). A second outlet line for use during a regeneration cycle is closed.

The system of FIG. 3A can also be described in terms of an integrated capture and regeneration method. During a capture cycle of the integrated method, contaminated water from the raw water tank flows into the two separation vessels (activated carbon EDI filtration column and activated graphite EDI concentrating column). This flow is controlled by a valve and a pump for each separation vessel as shown. Voltage is applied to the capture beds in each separation vessel. The water with contaminant removed by the capture beds is flowed to a clean water tank, which flow is controlled by further valves. Optionally the outlet flow of the separation vessels may be recirculated, as controlled by a recirculation valve, to the raw water tank for additional cycle(s) of purification.

Still referring to FIG. 3A, during a regeneration cycle, wash liquid from a waste water tank is flowed through the separation vessels and also controlled using the same valves and pumps as during the capture cycle. The voltage is modulated during the regeneration cycle to drive release of the bound contaminant from the capture bed as the wash liquid flows through the separation vessel. The wash liquid with released contaminant (“extract”) is flowed to a precipitator where it is mixed with regeneration fluid that is pumped into the precipitator. The regeneration fluid comprises a sequestration agent (e.g., a counter ion) that forms an aggregate contaminant phase with the released contaminant. The aggregate contaminant phase precipitates from the wash liquid in the precipitator and the solids are collected in a settler and removed. Wash liquid exiting the precipitator/settler is filtered and returned for continued use in washing the capture beds.

With reference to FIG. 3B, the wash liquid with released contaminant (“extract”) is brought into contact with a layer of agglomerating agent that facilitates and/or promotes formation of the aggregate formation phase. As illustrated, the layer of agglomerating agent is disposed in the precipitator. However, the layer of agglomerating agent may be positioned in any suitable location downstream of the separation vessels to facilitate and/or promote agglomeration of the ionic contaminant prior to the aqueous wash fluid being recirculated through the separation vessels.

In one aspect, the present invention provides a method of removing a contaminant from an aqueous mixture. The method comprises flowing a contaminated aqueous mixture comprising one or more ionic contaminants through a vessel that houses a carbon bed, wherein the one or more ionic contaminants are retained by the carbon bed. The method also comprises contacting the one or more ionic contaminants retained by the carbon bed with (a) a hydroxide and/or a peroxide, and (b) one or more cations selected from Ca²⁺, Mg²⁺, Zn²⁺, Sr²⁺, Al³⁺, B³⁺, and Fe³⁺. The (a) hydroxide and/or peroxide, and the (b) one or more cations are provided in a single aqueous liquid or in two or more separate aqueous liquids for contacting the one or more ionic contaminants. The method further comprises contacting the one or more ionic contaminants with an agglomerating agent. The method also further comprises forming an aggregate contaminant phase comprising the one or more ionic contaminants. The method also further comprises isolating the aggregate contaminant phase.

In some embodiments, the agglomerating agent contacts the one or more ionic contaminants before the (a) hydroxide and/or peroxide, and/or the (b) one or more cations contact the contaminants. In other embodiments, the agglomerating agent contacts the one or more ionic contaminants after the (a) hydroxide and/or peroxide, and/or the (b) one or more cations contact the contaminants. And, in some embodiments, the agglomerating agent contacts the one or more ionic contaminants simultaneously with the (a) hydroxide and/or peroxide, and/or the (b) one or more cations (e.g., the single aqueous liquid or two or more aqueous liquids comprise the agglomerating agent).

In some embodiments, the agglomerating agent comprises an oil, a terpene, a fatty acid ester, or any combination thereof. For example, the oil may be selected from coconut oil, corn oil, cottonseed oil, olive oil, palm oil, peanut oil, rapeseed oil (e.g., canola oil), safflower oil, sesame oil, soybean oil, sunflower oil, or any combination thereof. In some embodiments, the oil comprises safflower oil, rapeseed oil, or any combination thereof. In some embodiments, the terpene is selected from myrcene, menthol, limonene, carvone, hinokitiol, linalool, or any combination thereof. In some embodiments, the fatty acid ester is ethyl octanoate. And, in some embodiments, the agglomerating agent is selected from safflower oil, rapeseed oil, limonene, ethyl octanoate, or any combination thereof.

In another aspect, the present invention provides a method of removing a contaminant from an aqueous mixture. The method comprises flowing a contaminated aqueous mixture comprising one or more ionic contaminants through a vessel that houses a carbon bed, wherein the one or more ionic contaminants are retained by the carbon bed. The method also comprises contacting the one or more ionic contaminants retained by the carbon bed with (a) a hydroxide and/or a peroxide, and (b) one or more cations selected from Ca²⁺, Mg²⁺, Zn²⁺, Sr²⁺, Al³⁺, B³⁺, and Fe³⁺. The (a) hydroxide and/or peroxide, and the (b) one or more cations are provided in a single aqueous liquid or in two or more separate aqueous liquids for contacting the one or more ionic contaminants. The method further comprises contacting the single aqueous liquid or two or more separate aqueous liquids with an agglomerating agent to form an aggregate contaminant phase comprising the one or more ionic contaminants. The step of contacting the single aqueous liquid or two or more separate aqueous liquids with the agglomerating agent occurs after contacting the one or more ionic contaminants retained by the carbon bed with the (a) hydroxide and/or peroxide and the (b) one or more cations. The method also further comprises isolating the aggregate contaminant phase.

In some embodiments, the agglomerating agent comprises an oil, a terpene, a fatty acid ester, or any combination thereof. For example, the oil may be selected from coconut oil, corn oil, cottonseed oil, olive oil, palm oil, peanut oil, rapeseed oil (e.g., canola oil), safflower oil, sesame oil, soybean oil, sunflower oil, or any combination thereof. In some embodiments, the oil comprises safflower oil, rapeseed oil, or any combination thereof. In some embodiments, the terpene is selected from myrcene, menthol, limonene, carvone, hinokitiol, linalool, or any combination thereof. In some embodiments, the fatty acid ester is ethyl octanoate. And, in some embodiments, the agglomerating agent is selected from safflower oil, rapeseed oil, limonene, ethyl octanoate, or any combination thereof.

In a further aspect, the present invention provides a method of removing a contaminant from an aqueous mixture. The method comprises flowing a contaminated aqueous mixture comprising one or more ionic contaminants through a vessel that houses a carbon bed, wherein the one or more ionic contaminants are retained by the carbon bed. The method also comprises contacting the one or more ionic contaminants retained by the carbon bed with (a) sodium hydroxide and/or hydrogen peroxide, and (b) calcium hydroxide, aluminum hydroxide, and/or aluminum sulfate. The (a) sodium hydroxide and/or hydrogen peroxide, and the (b) calcium hydroxide, aluminum hydroxide, and/or aluminum sulfate are provided in a single aqueous liquid or in two or more separate aqueous liquids for contacting the one or more ionic contaminants. The method further comprises contacting the one or more ionic contaminants with an agglomerating agent. The method also further comprises forming an aggregate contaminant phase comprising the one or more ionic contaminants. The method also further comprises isolating the aggregate contaminant phase.

In some embodiments, the agglomerating agent contacts the one or more ionic contaminants before the (a) sodium hydroxide and/or hydrogen peroxide, and/or the (b) calcium hydroxide, aluminum hydroxide, and/or aluminum sulfate contact the contaminants. In other embodiments, the agglomerating agent contacts the one or more ionic contaminants after the (a) sodium hydroxide and/or hydrogen peroxide, and/or the (b) calcium hydroxide, aluminum hydroxide, and/or aluminum sulfate contact the contaminants. And, in some embodiments, the agglomerating agent contacts the one or more ionic contaminants simultaneously with the (a) sodium hydroxide and/or hydrogen peroxide, and/or the (b) calcium hydroxide, aluminum hydroxide, and/or aluminum sulfate (e.g., the single aqueous liquid or two or more aqueous liquids comprise the agglomerating agent).

In some embodiments, the agglomerating agent comprises an oil, a terpene, a fatty acid ester, or any combination thereof. For example, the oil may be selected from coconut oil, corn oil, cottonseed oil, olive oil, palm oil, peanut oil, rapeseed oil (e.g., canola oil), safflower oil, sesame oil, soybean oil, sunflower oil, or any combination thereof. In some embodiments, the oil comprises safflower oil, rapeseed oil, or any combination thereof. In some embodiments, the terpene is selected from myrcene, menthol, limonene, carvone, hinokitiol, linalool, or any combination thereof. In some embodiments, the fatty acid ester is ethyl octanoate. And, in some embodiments, the agglomerating agent is selected from safflower oil, rapeseed oil, limonene, ethyl octanoate, or any combination thereof.

In yet another aspect, the present invention provides a method of removing a contaminant from an aqueous mixture. The method comprises flowing a contaminated aqueous mixture comprising one or more ionic contaminants through a vessel that houses a carbon bed, wherein the one or more ionic contaminants are retained by the carbon bed. The method also comprises contacting the one or more ionic contaminants retained by the carbon bed with (a) sodium hydroxide and/or hydrogen peroxide, and (b) calcium hydroxide, aluminum hydroxide, and/or aluminum sulfate. The (a) sodium hydroxide and/or hydrogen peroxide, and the (b) calcium hydroxide, aluminum hydroxide, and/or aluminum sulfate are provided in a single aqueous liquid or in two or more separate aqueous liquids for contacting the one or more ionic contaminants. The method further comprises contacting the single aqueous liquid or two or more separate aqueous liquids with an agglomerating agent to form an aggregate contaminant phase comprising the one or more ionic contaminants. The step of contacting the single aqueous liquid or two or more separate aqueous liquids with the agglomerating agent occurs after contacting the one or more ionic contaminants retained by the carbon bed with the (a) sodium hydroxide and/or hydrogen peroxide, and the (b) calcium hydroxide, aluminum hydroxide, and/or aluminum sulfate. The method also further comprises isolating the aggregate contaminant phase.

In some embodiments, the agglomerating agent comprises an oil, a terpene, a fatty acid ester, or any combination thereof. For example, the oil may be selected from coconut oil, corn oil, cottonseed oil, olive oil, palm oil, peanut oil, rapeseed oil (e.g., canola oil), safflower oil, sesame oil, soybean oil, sunflower oil, or any combination thereof. In some embodiments, the oil comprises safflower oil, rapeseed oil, or any combination thereof. In some embodiments, the terpene is selected from myrcene, menthol, limonene, carvone, hinokitiol, linalool, or any combination thereof. In some embodiments, the fatty acid ester is ethyl octanoate. And, in some embodiments, the agglomerating agent is selected from safflower oil, rapeseed oil, limonene, ethyl octanoate, or any combination thereof.

### VI. Examples

### Example 1: Regeneration of Carbon Substrate

An experiment was carried out to test the regeneration of carbon substrate using calcium hydroxide and calcium chloride. The experiment tested the capture, regeneration, and sequestration of (i) octanoic acid and (ii) PFOA on carbon substrate using calcium hydroxide or calcium chloride as sequestration agent. Octanoic acid is a simulant of PFAS, which has similar behavior in water but not the disposal issues of actual PFAS. Visual indications and mass measurements were used to determine the results of the experiment.

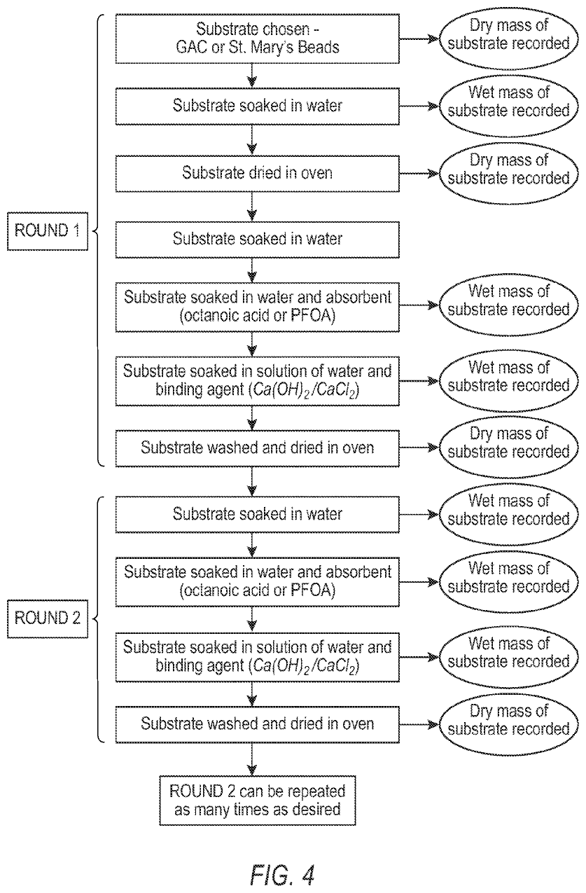

FIG. 4 shows a flowchart of the testing method. A first carbon substrate was selected, either granulated activated carbon (GAC) or St Mary's carbon beads. The dry mass of the substrate was recorded. The substrate was next soaked in water and the wet mass mas recorded. The substrate was then dried in an oven and the mass after drying recorded. The substrate was next soaked in water followed by soaking overnight in a mixture of water and a specified and recorded mass of contaminant-either octanoic acid (OA) or PFOA. The wet mass of the substrate was then recorded to determine capture of OA/PFOA. The substrate was next soaked overnight in a solution of water and a specified and recorded mass of sequestration agent—either Ca(OH)₂ or CaCl₂). NaOH was also added in the case of CaCl₂). After soaking and washing, the wet mass of the substrate was recorded. The substrate was then dried in oven and the dry mass after drying was recorded. The sequestration agent solution was dried and the mass of precipitate from the solution was recorded.

The same basic procedure can then be repeated for a second and subsequent rounds of capture, regeneration and sequestration with mass measurements. Second and third rounds were completed for the present experiment. The dried substrate from the final step of Round 1 was soaked in water and the wet mass of substrate was recorded. Next, the substrate was soaked overnight in water and a contaminant-either octanoic acid (OA) or PFOA. The wet mass of the substrate was then recorded to determine capture of OA/PFOA. The substrate was next soaked in solution of water and a sequestration agent-either Ca(OH)₂ or CaCl₂). NaOH was also added in the case of CaCl₂). After soaking and washing, the wet mass of the substrate was recorded. The substrate was then dried in oven and the dry mass after drying was recorded. The sequestration agent solution was dried and the mass of precipitate from the solution was recorded.

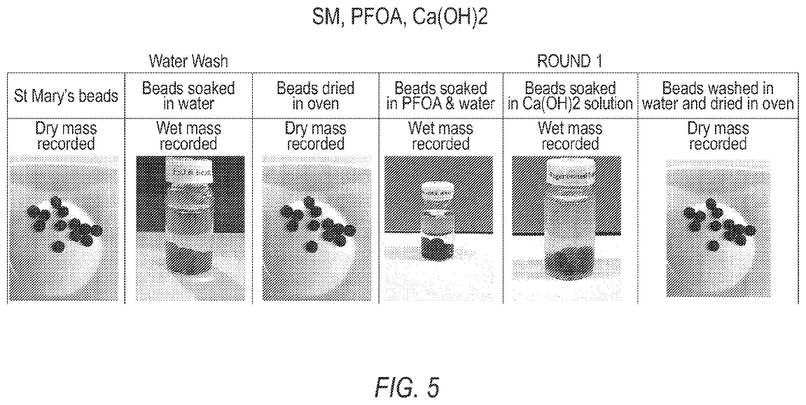

Tables 1-4 show the results of the mass measurements for the experiment over the course of the initial wash procedure and three rounds of capture, regeneration and sequestration. Table 5 shows the recovered mass of precipitate recovered for each round. FIG. 5 shows visual observation of St. Mary's Beads (activated carbon beads) over the course of the first round of testing.

The results demonstrated that the carbon substrates were able to releasably capture OA and PFOA, and that the sequestration agent (calcium hydroxide or calcium chloride) was able to bind the OA or PFOA, be released from the carbon substrate, and be sequestered as a precipitate. The process was repeatable, showing the ability to capture OA and PFOA on the carbon substrate and subsequently regenerate the carbon substrate for multiple uses.

TABLE 1
Water Wash.

| | Fresh Beads | Wet with | Post Water | Water wash |
|---|---|---|---|---|
| | Dry Mass | water mass | Dry mass | delta mass |
| Vial Group | (g) | (g) | (g) | (g) |
| SM, PFOA, | 2.5545 | 3.3140 | Not taken | NA |
| Ca(OH)₂ (1) | | | | |
| SM, OA, | 2.5425 | 3.3125 | 2.5459 | 0.0034 |
| Ca(OH)₂ (2) | | | | |
| SM, PFOA, | 2.5320 | 3.3114 | 2.5340 | 0.0020 |
| CaCl₂ (3) | | | | |
| GAC, PFOA, | 0.5209 | 1.2054 | 0.4976 | −0.0233 |
| Ca(OH)₂ (4) | | | | |
| GAC, PFOA, | 0.5295 | 1.4055 | 0.5026 | −0.0269 |
| CaCl₂ (5) | | | | |
| GAC, OA, | 0.5220 | 1.3529 | 0.4930 | −0.0290 |
| CaCl₂ (6) | | | | |

TABLE 2
First Round of Capture/Release

| | Vial | | | | | |
|---|---|---|---|---|---|---|
| | Group | | | | | |
| | 1 | 2 | 3 | 4 | 5 | 6 |
| Mass of | 0.0963 | 0.1203 | 0.0581 | 0.0582 | 0.0528 | 0.1258 |
| contaminant | | | | | | |
| (OA/PFOA) | | | | | | |
| (g) | | | | | | |
| Wet mass of | 3.3308 | 3.3151 | 3.3319 | 1.2376 | 1.4704 | 1.3942 |
| beads after | | | | | | |
| OA/PFOA | | | | | | |
| (g) | | | | | | |
| Mass of | 0.0075 | 0.0344 | 0.0089 | 0.0085 | 0.0120 | 0.0603 |
| sequestrant | | | | | | |
| Ca(OH)2/ | | | | | | |
| CaCl2 (g) | | | | | | |
| Wet mass after | 3.3345 | 3.3209 | 3.3315 | 1.2052 | 1.4067 | 1.3618 |
| regen 1 (g) | | | | | | |
| Dry mass after | 2.5641 | 2.5470 | 2.5419 | 0.5272 | 0.5391 | 0.5756 |
| regen 1 (g) | | | | | | |
| First regen dry | 0.0096 | 0.0011 | 0.0079 | 0.0296 | 0.0365 | 0.0826 |
| delta mass | | | | | | |
| (g) | | | | | | |
| Bead/GAC | 99.6242 | 99.9568 | 99.6882 | 94.0514 | 92.7378 | 83.2454 |
| mass regenera- | | | | | | |
| tion (%) | | | | | | |

TABLE 3
Second Round of Capture/Release

| | Vial | | | | | |
|---|---|---|---|---|---|---|
| | Group | | | | | |
| | 1 | 2 | 3 | 4 | 5 | 6 |
| Wet mass after | 3.3306 | 3.2067 | 3.3194 | 1.1961 | 1.3947 | 1.3270 |
| soaking in | | | | | | |
| water (g) | | | | | | |
| Mass of | 0.0596 | 0.1204 | 0.0501 | 0.0510 | 0.0514 | 0.1202 |
| contaminant | | | | | | |
| (OA/PFOA) | | | | | | |
| (g) | | | | | | |
| Wet mass of | 3.3390 | 3.3017 | 3.3291 | 1.2529 | 1.4315 | 1.3587 |
| beads after | | | | | | |
| OA/PFOA | | | | | | |
| (g) | | | | | | |
| Mass of | 0.0079 | 0.0388 | 0.0231 | 0.0133 | 0.0360 | 0.0726 |
| sequestrant | | | | | | |
| Ca(OH)2/ | | | | | | |
| CaCl2 (g) | | | | | | |
| Wet mass after | 3.3360 | 3.3209 | 3.3289 | 1.2077 | 1.3988 | 1.3762 |
| regen 2 (g) | | | | | | |
| Dry mass after | 2.5548 | 2.5571 | 2.5350 | 0.5281 | 0.5650 | 0.5529 |
| regen 2 (g) | | | | | | |
| Second regen | 0.0003 | 0.0112 | 0.0010 | 0.0305 | 0.0624 | 0.0599 |
| dry delta mass | | | | | | |
| (g) | | | | | | |
| Bead/GAC | 99.9883 | 99.5601 | 99.9605 | 93.8706 | 87.5846 | 87.8499 |
| mass regenera- | | | | | | |
| tion (%) | | | | | | |

TABLE 4
Third Round of Capture/Release

| | Vial | | | | | |
|---|---|---|---|---|---|---|
| | Group | | | | | |
| | 1 | 2 | 3 | 4 | 5 | 6 |
| Wet mass after | 3.3190 | 3.2392 | 3.3181 | 1.1806 | 1.4195 | 1.2767 |
| soaking in | | | | | | |
| water (g) | | | | | | |
| Mass of | 0.0543 | 0.1116 | 0.0531 | 0.0511 | 0.0522 | 0.1272 |
| contaminant | | | | | | |
| (OA/PFOA) | | | | | | |
| (g) | | | | | | |
| Wet mass of | 3.3317 | 3.3133 | 3.3310 | 1.2250 | 1.4574 | 1.3020 |
| beads after | | | | | | |
| OA/PFOA | | | | | | |
| (g) | | | | | | |
| Mass of | 0.0102 | 0.0403 | 0.0286 | 0.0151 | 0.0391 | 0.0811 |
| sequestrant | | | | | | |
| Ca(OH)2/ | | | | | | |
| CaCl2 (g) | | | | | | |
| Wet mass after | 3.3303 | 3.3130 | 3.3310 | 1.2189 | 1.4366 | 1.2835 |
| regen 3 (g) | | | | | | |
| Dry mass after | 2.5559 | 2.5459 | 2.5376 | 0.5461 | 0.5961 | 0.5781 |
| regen 3 (g) | | | | | | |
| Third regen dry | 0.0014 | 0.0034 | 0.0056 | 0.0252 | 0.0666 | 0.0561 |
| delta mass | | | | | | |
| (g) | | | | | | |
| Bead/GAC | 99.9452 | 99.8665 | 99.7790 | 94.9357 | 86.7489 | 88.6207 |
| mass regenera- | | | | | | |
| tion (%) | | | | | | |

TABLE 5
Recovered Mass of Precipitate

| | Vial | | | | | |
|---|---|---|---|---|---|---|
| | Group | | | | | |
| | 1 | 2 | 3 | 4 | 5 | 6 |
| Regeneration | Calcium | Calcium | Calcium | Calcium | Calcium | Calcium |
| Precipitate | perfluoro- | octanoate | perfluoro- | perfluoro- | perfluoro | octanoate |
| | octanoate | | octanoate | octanoate | octanoate | |

ROUND 1

| | | | | | | |
|---|---|---|---|---|---|---|
| Expected mass | 0.088 | 0.136 | 0.061 | 0.061 | 0.055 | 0.142 |
| of precipitate | | | | | | |
| (g) | | | | | | |
| Actual mass of | 0.073 | 0.106 | 0.019 | 0.052 | 0.039 | 0.072 |
| precipitate | | | | | | |
| (g) | | | | | | |
| Recovered Yield | 83.66 | 77.94 | 30.43 | 86.04 | 71.38 | 50.21 |
| (%) | | | | | | |

ROUND 2

| | | | | | | |
|---|---|---|---|---|---|---|
| Expected mass | 0.064 | 0.136 | 0.054 | 0.055 | 0.055 | 0.136 |
| of precipitate | | | | | | |
| (g) | | | | | | |
| Actual mass of | 0.053 | 0.130 | 0.028 | 0.035 | 0.038 | 0.128 |
| precipitate | | | | | | |
| (g) | | | | | | |
| Recovered Yield | 83.49 | 95.60 | 53.08 | 63.67 | 68.31 | 93.83 |
| (%) | | | | | | |

ROUND 3

| | | | | | | |
|---|---|---|---|---|---|---|
| Expected mass | 0.057 | 0.126 | 0.056 | 0.053 | 0.055 | 0.140 |
| of precipitate | | | | | | |
| (g) | | | | | | |
| Actual mass of | 0.050 | 0.122 | 0.050 | 0.038 | 0.048 | 0.106 |
| precipitate | | | | | | |
| (g) | | | | | | |
| Recovered Yield | 87.50 | 96.28 | 88.29 | 70.22 | 87.36 | 73.89 |
| (%) | | | | | | |

### Example 2: Carbon Bed Regeneration with Acid Wash

To assess regeneration capability, the sorption isotherm of fresh activated carbon (Calgon F400) was compared to the sorption isotherm of regenerated activated carbon for a model PFAS compound, perfluoroctanoic acid (PFOA).

### Procedure:

TABLE 6
Raw data for each of the 20 flasks tested. All prewash adsorbances were measured on the 13 ml method.

| | PFOA | Activated | | | | | | | UV |
|---|---|---|---|---|---|---|---|---|---|
| | concentration | Carbon | Regen | Water | Acid | Pre Wash | Post Wash | pH post | Method |
| Flask | (μg/kg) | Mass (g) | Washes | Washes | Washes | Absorbance | Absorbance | Wash | Post Wash |
| 1 | 225834 | 0.7503 | 2 | 3 | 0 | 0.53 | 1.338 | 6.49 | 1.5 mL |
| 2 | 225834 | 0.7501 | 2 | 3 | 0 | 0.577 | 1.47 | 6.75 | Method |
| 3 | 225834 | 0.7506 | 2 | 3 | 1 | 0.502 | 0.93 | 4.15 | 13 mL |
| 4 | 225834 | 0.7501 | 2 | 3 | 1 | 0.374 | 0.688 | 4.18 | method |
| 5 | 225834 | 0.75 | 2 | 2 | 0 | 0.881 | 1.693 | 7.34 | 1.5 mL |
| 6 | 225834 | 0.7507 | 2 | 2 | 0 | 0.471 | 1.317 | 7.29 | Method |
| 7 | 225834 | 0.7507 | 2 | 2 | 0 | 0.743 | 1.493 | 7.07 | |
| 8 | 225834 | 0.7508 | 2 | 2 | 1 | 0.593 | 0.794 | 4.02 | 13 mL |
| 9 | 225834 | 0.7504 | 2 | 2 | 1 | 0.765 | 0.888 | 4.05 | Method |
| 10 | 225834 | 0.7503 | 2 | 2 | 1 | 0.708 | 0.909 | 4.05 | |
| 11 | 225834 | 0.7501 | 1 | 3 | 0 | 0.663 | 1.448 | 6.82 | 1.5 mL |
| 12 | 225834 | 0.7505 | 1 | 3 | 0 | 0.619 | 1.407 | 6.64 | Method |
| 13 | 225834 | 0.7506 | 1 | 3 | 0 | 0.459 | 1.331 | 6.58 | |
| 14 | 225834 | 0.7503 | 1 | 3 | 1 | 0.636 | 0.912 | 4.12 | 13 mL |
| 15 | 225834 | 0.7503 | 1 | 3 | 1 | 0.473 | 0.949 | 4.1 | Method |
| 16 | 225834 | 0.7504 | 1 | 3 | 1 | 0.706 | 0.927 | 4.11 | |
| 17 | 225834 | 0.7501 | 1 | 2 | 0 | 0.732 | 1.516 | 7.24 | 1.5 mL |
| 18 | 225834 | 0.7507 | 1 | 2 | 0 | 0.4 | 1.215 | 7.25 | Method |
| 19 | 225834 | 0.7507 | 1 | 2 | 1 | 0.696 | 0.72 | 3.99 | 13 mL |
| 20 | 225834 | 0.7506 | 1 | 2 | 1 | 1.147 | 1.052 | 3.93 | Method |

Calgon F400 activated carbon was rinsed with DI water and dried at 100° C. in a vacuum oven. 0.1 g+/−0.001 PFOA was weighed and placed into a 2 L clean glass bottle. 2 L of deionized water was added to bottle, via volumetric flask. Actual input weights and volumes were recorded. PFOA was stirred until completely dissolved.

102.70 g of DI water, +/−1 g, was weighed into each of 20 250 ml Erlenmeyer flasks according to Table 6. With a micropipette 22.1 mL of PFOA stock was added, 1277345 μg/kg. Calgon F400 activated carbon was measured using a calibrated balance and placed 0.75, +/−0.001 g, each in 20 glass 250 ml Erlenmeyer flasks and shaken.

2 oz. glass sample vials were prepared by rinsing with DI water and removing foam seal from cap. After 18 hours on the shaker, with a pipette (rinsed with DI water), a 2 oz. sample was removed from each condition, switching tips between samples, being careful not to remove activated carbon, and vials were rinsed with sample prior to filling. The remaining PFOA solution was removed from each flask and placed in waste.

A solution of 1 g/L Ca(OH)₂ (regeneration fluid) was prepared, and mixed on a stir plate until all Ca(OH)₂ was dissolved. 1% acetic acid wash was prepared by diluting 5% vinegar. 125 ml of Ca(OH)₂ stock solution was measured into each flask and shaken at 150 rpm for 1 hour. Regeneration solution was removed by pouring off liquid. Rinses were continued according to Table 6. Any following regeneration fluid rinse was shaken at 150 rpm for an hour, following acid or water rinses occurred for 30 minutes at 150 rpm. Any acid rinses were completed after the regeneration wash(es) and prior to the water washes. The solutions were poured off before the next rinse.

After rinsing, each flask was dosed again with 225834.6572 μg/kg PFOA solution. 102.70 g of DI water, +/−1 g, was weighed into each of the 20 250 ml Erlenmeyer flasks according to Table 6. 22.1 mL of PFOA stock was added, 1277345.346 μg/kg. Flasks were tipped slowly to ensure all activated carbon was submerged in water and not stuck to the side, and placed on the shaker at 150 rpm for 18 hours.

All samples were run with the UV-Visible Spectrometry method to measure equilibrium PFOA concentrations post regeneration. The pH was checked when samples were taken.

### UV-Visible Spectrometry Procedure

Two calibration standards were made at 10 and 11 points each using a micropipette, DI water, and PFOA batch solution. The 10 point curve was used for post-regeneration non-acid rinsed samples, and used 1.5 mL of standard as follows: 0, 600.36, 1000.59, 2000.33, 4257.84, 10644.60, 14902.44, 19160.28, 25547.03, and 38320.55 μg/kg. The 11 point curve was used for fresh carbon and post-regeneration acid rinsed samples, and used 13 mL of the following standards: 0, 50.24, 100.48, 200.12, 400.24, 800.47, 1000.59, 1500.46, 2000.33, 2554.70, and 2980.49 μg/kg. Standards were filtered into DI rinsed vials using 0.22 μm PVDF/GF syringe filters. All calibration samples were prepared with their appropriate quantity of standard mixed with 2.5 mL 1-octanol, and 1 mL methylene blue solution. Calibration samples were ran on UV-Visible method, to generate calibration curves.

0.22 μm 13 mm PVDF/GF syringe filter was used to filter each of the samples into new (DI water rinsed) vials, changing syringes and filters between samples. Samples were filtered because residual activated carbon will affect absorbance readings. All samples were run on UV-Visible Spectrometry methods to measure equilibrium PFOA concentrations for fresh activated carbon.

The UV Spectrophotometer was set to 664 nm. The organic and aqueous phases were separated cleanly in a test tube, and organic phase was removed, and placed into a cuvette. The cuvette was placed, with water-saturated octanol, in the UV Spectrophotometer to zero the machine, then the cuvette with sample was placed and ran to measure UV absorbance.

pH probe was removed from storage solution, rinsed with deionized water, and gently wiped with Kimwipe. 4.01, 7.01, and 10.01 solutions were placed in vials. Probe was calibrated to 7.01, then to 4.01 and 10.01, then pH was checked for the 7.01 calibration again. After calibration, each flask was tested directly (with carbon in the flask), swirling the flask while testing and rinsing the probe between standards.

### Results:

Table 7 shows equilibrium concentrations and percent recovery of sorptive capacity for each sample. Percent recovery was calculated by dividing the mass sorbed for fresh carbon by the mass sorbed for regenerated carbon and multiplying by 100.

TABLE 7

| | | | | | Fresh | Regenerated | Fresh | Regenerated | |
|---|---|---|---|---|---|---|---|---|---|
| | | | | | Carbon | Carbon | Carbon | Carbon | |
| | Activated | | | | Equilibrium | Equilibrium | Mass | Mass | Percent |
| Sample | Carbon | Regen | Water | Acid | Conc. | Conc. | Sorbed | Sorbed | Recovery of |
| Number | Mass (g) | Washes | Washes | Washes | (μg/kg) | (μg/kg) | (μg/g) | (μg/g) | Capacity |
| 1 | 0.7503 | 2 | 3 | 0 | 313 | 91134 | 37496 | 22396 | 59.73% |
| 2 | 0.7501 | 2 | 3 | 0 | 354 | 104204 | 37499 | 20228 | 53.94% |
| 3 | 0.7506 | 2 | 3 | 1 | 289 | 741 | 37485 | 37410 | 99.80% |
| 4 | 0.7501 | 2 | 3 | 1 | 192 | 462 | 37526 | 37481 | 99.88% |
| 5 | 0.7500 | 2 | 2 | 0 | 680 | 129296 | 37450 | 16057 | 42.88% |
| 6 | 0.7507 | 2 | 2 | 0 | 264 | 89169 | 37484 | 22710 | 60.59% |
| 7 | 0.7507 | 2 | 2 | 0 | 520 | 106613 | 37442 | 19812 | 52.91% |
| 8 | 0.7508 | 2 | 2 | 1 | 369 | 576 | 37462 | 37427 | 99.91% |
| 9 | 0.7504 | 2 | 2 | 1 | 544 | 688 | 37453 | 37429 | 99.94% |
| 10 | 0.7503 | 2 | 2 | 1 | 482 | 715 | 37468 | 37429 | 99.90% |
| 11 | 0.7501 | 1 | 3 | 0 | 436 | 101938 | 37486 | 20605 | 54.97% |
| 12 | 0.7505 | 1 | 3 | 0 | 393 | 97809 | 37473 | 21280 | 56.79% |
| 13 | 0.7506 | 1 | 3 | 0 | 255 | 90475 | 37491 | 22496 | 60.00% |
| 14 | 0.7503 | 1 | 3 | 1 | 410 | 718 | 37480 | 37429 | 99.86% |
| 15 | 0.7503 | 1 | 3 | 1 | 266 | 766 | 37504 | 37421 | 99.78% |
| 16 | 0.7504 | 1 | 3 | 1 | 480 | 737 | 37463 | 37421 | 99.89% |
| 17 | 0.7501 | 1 | 2 | 0 | 508 | 109061 | 37474 | 19420 | 51.82% |
| 18 | 0.7507 | 1 | 2 | 0 | 210 | 80049 | 37493 | 24226 | 64.61% |
| 19 | 0.7507 | 1 | 2 | 1 | 470 | 495 | 37450 | 37446 | 99.99% |
| 20 | 0.7506 | 1 | 2 | 1 | 1045 | 906 | 37360 | 37383 | 100.06% |

Table 8 is a summary table showing the average percent recovery of sorptive capacity for the high number and low number of rinses for each process step. The difference between the percent recovery for the high and low number of rinses for each demonstrates the level of importance of each washing step (regeneration fluid, wash water, acetic acid rinse) on the percent recovery.

TABLE 8

| | Average | Average | Average | Average | Average | Average |
|---|---|---|---|---|---|---|
| | Percent | Percent | Percent | Percent | Percent | Percent |
| | Recovery | Recovery | Recovery | Recovery | Recovery | Recovery |
| | for all Low | for all High | for all Low | for all High | for all Low | for all High |
| | Number of | Number of | Number of | Number of | Number | Number |
| | Regen | Regen | Water | Water | of Acid | of Acid |
| | Rinses | Rinses | Rinses | Rinses | Rinses | Rinses |
| Average Percent | 78.78% | 76.95% | 77.26% | 78.46% | 55.82% | 99.90% |
| Recovery for each | | | | | | |
| rinse condition | | | | | | |

| | | | |
|---|---|---|---|
| Difference in | −1.83% | 1.20% | 44.08% |
| Average Percent | | | |
| Recovery from High | | | |
| Number of Rinses to | | | |
| Low Number of | | | |
| Rinses | | | |

Table 9 shows the average mass sorbed and percent standard deviation for all duplicates in each condition.

TABLE 9

| | | | | | Percent Standard | Percent | Number of |
|---|---|---|---|---|---|---|---|
| | Regen | Water | Acid | Average Mass | Deviation in | Recovery of | Samples in |
| Condition | Washes | Washes | Washes | Sorbed (μg/g) | Mass Sorbed | Capacity | Subset |
| Fresh | — | — | — | 37472 | 0.0903% | — | 20 |
| Regenerated | 2 | 3 | 0 | 21312 | 0.0001% | 56.84% | 2 |
| Regenerated | 2 | 3 | 1 | 37446 | 0.1348% | 99.84% | 2 |
| Regenerated | 2 | 2 | 0 | 19526 | 17.0833% | 52.13% | 3 |
| Regenerated | 2 | 2 | 1 | 37429 | 0.0027% | 99.91% | 3 |
| Regenerated | 1 | 3 | 0 | 21460 | 4.4660% | 57.25% | 3 |
| Regenerated | 1 | 3 | 1 | 37423 | 0.0123% | 99.84% | 3 |
| Regenerated | 1 | 2 | 0 | 21823 | 15.5709% | 58.22% | 2 |
| Regenerated | 1 | 2 | 1 | 37414 | 0.1196% | 100.03% | 2 |

Table 10 is a summary table showing the average pH for the high number and low number of rinses for each process step. The difference between the pH for the high and low number of rinses for each demonstrates the level of importance of each washing step (regeneration fluid, wash water, acetic acid rinse) in changing the pH of the process.

TABLE 10

| | Average | Average | Average | Average | Average | Average |
|---|---|---|---|---|---|---|
| | pH for | pH for | pH for | pH for | pH for | pH for |
| | all Low | all High | all Low | all High | all Low | all High |
| | Number of | Number of | Number of | Number of | Number of | Number of |
| | Regen | Regen | Water | Water | Acid | Acid |
| | Rinses | Rinses | Rinses | Rinses | Rinses | Rinses |
| Average pH for each | 5.478 | 5.539 | 5.623 | 5.394 | 6.947 | 4.07 |
| rinse condition | | | | | | |

| | | | |
|---|---|---|---|
| Difference in | 0.061 | −0.229 | −2.877 |
| Average pH from | | | |
| High Number of | | | |
| Rinses to Low | | | |
| Number of Rinses | | | |

### Conclusions

The study demonstrated successful regeneration of the carbon to capture PFOA. Percent recovery along all conditions ranged from 42.88% to 100.06%. The average percent recovery for samples seemed to be the most affected by acid washing. Increasing the number of regeneration rinses from 1 to 2 decreased the average percent recovery by 1.83%, while increasing the water washes from 2 to 3 increased percent recovery by 1.20% (Table 8). Increasing the number of acid washes from 0 to 1, however, increased percent recovery by 44.08%, bringing the average percent recovery for all acid washed samples to 99.90% (Table 8). This indicates that a decrease in both the number of regeneration washes and the number of water washes has little effect on the process.

The pH was also most greatly affected by the acid washing step, dropping by 2.877 on average for acid washed samples (Table 10). Increasing water rinses also decreased the pH (Table 10), likely due to rinsing off excess regeneration fluid. Increasing the regeneration rinses slightly increased the pH on average, likely because regeneration fluid is basic.

Low percent standard deviation for fresh samples demonstrated high repeatability for fresh carbon (Table 9). For regenerated samples, percent standard deviation remained below 1% for all samples except for 3 samples: 2 Regen Washes/2 Water Washes/0 Acid Washes, 1 Regen Wash/3 Water Washes/0 Acid Washes, and 1 Regen Wash/2 Water Washes/0 Acid Washes.

### Example 3: Regeneration of Samples with Mixed Contaminant

Experiments were performed to evaluate the performance of a regeneration system for capturing contaminants from complex samples more closely resembling groundwater. Complex samples were modeled using a mixture of PFOA, PFNA, and PFOS, with and without humic acid.

Calgon F400 activated carbon was rinsed with DI water and dried. PFOA, K-PFOS, and PFNA stock solutions were prepared. A humic acid solution was also prepared. Fresh carbon samples were prepared and tested as shown in Table 11. Regenerated samples were also prepared and tested. For the regenerated samples, carbon samples were exposed to contaminant solutions as shown in Table 11 and allowed to reach equilibrium, then samples were regenerated with Ca(OH)₂ solution, regeneration solution was poured off, carbon bed samples were rinsed again with regeneration solution, and then finally carbon samples were treated a second time with same contaminant solutions as shown in Table 11. Absorption of contaminant was tested in fresh and regenerated carbon bed samples with and without humic acid as shown in Table 11.

TABLE 11
Experimental setup for testing

| Volume | Volume | Volume | Calgon | | |
|---|---|---|---|---|---|
| 38451.0 g/kg | 43131.6 g/kg | 46461.5 g/kg | F400 | | Humic Acid |
| PFOA stock | PFNA stock | PFOS stock | Mass | Regeneration | Concentration |
| added (ml) | added (ml) | added (ml) | (g) | Condition | (mg/l) |
| 0 | 0 | 0 | 0.7502 | Fresh and | 0 |
| | | | | Loaded | |
| 0.01 | 0.01 | 0.01 | 0.7508 | Fresh and | 0 |
| | | | | Loaded | |
| 0.1 | 0.1 | 0.1 | 0.7501 | Fresh and | 0 |
| | | | | Loaded | |
| 1 | 1 | 1 | 0.7504 | Fresh and | 0 |
| | | | | Loaded | |
| 10 | 10 | 10 | 0.7502 | Fresh and | 0 |
| | | | | Loaded | |
| 0 | 0 | 0 | 0.7502 | Regenerated | 0 |
| | | | | Reloaded | |
| 0.01 | 0.01 | 0.01 | 0.7506 | Regenerated | 0 |
| | | | | Reloaded | |
| 0.1 | 0.1 | 0.1 | 0.7508 | Regenerated | 0 |
| | | | | Reloaded | |
| 1 | 1 | 1 | 0.7501 | Regenerated | 0 |
| | | | | Reloaded | |
| 10 | 10 | 10 | 0.7502 | Regenerated | 0 |
| | | | | Reloaded | |
| 0 | 0 | 0 | 0.7506 | Fresh and | 0 |
| | | | | Loaded | |
| 0.01 | 0.01 | 0.01 | 0.7508 | Fresh and | 10 |
| | | | | Loaded | |
| 0.1 | 0.1 | 0.1 | 0.7503 | Fresh and | 10 |
| | | | | Loaded | |
| 1 | 1 | 1 | 0.7504 | Fresh and | 10 |
| | | | | Loaded | |
| 10 | 10 | 10 | 0.7302 | Fresh and | 10 |
| | | | | Loaded | |
| 0 | 0 | 0 | 0.7507 | Regenerated | 10 |
| | | | | Reloaded | |
| 0.01 | 0.01 | 0.01 | 0.7506 | Regenerated | 10 |
| | | | | Reloaded | |
| 0.1 | 0.1 | 0.1 | 0.7503 | Regenerated | 10 |
| | | | | Reloaded | |
| 1 | 1 | 1 | 0.7508 | Regenerated | 10 |
| | | | | Reloaded | |
| 10 | 10 | 10 | 0.75 | Regenerated | 10 |
| | | | | Reloaded | |
| 0 | 0 | 0 | 0 | N/A | 10 |
| 10 | 10 | 10 | 0 | N/A | 0 |

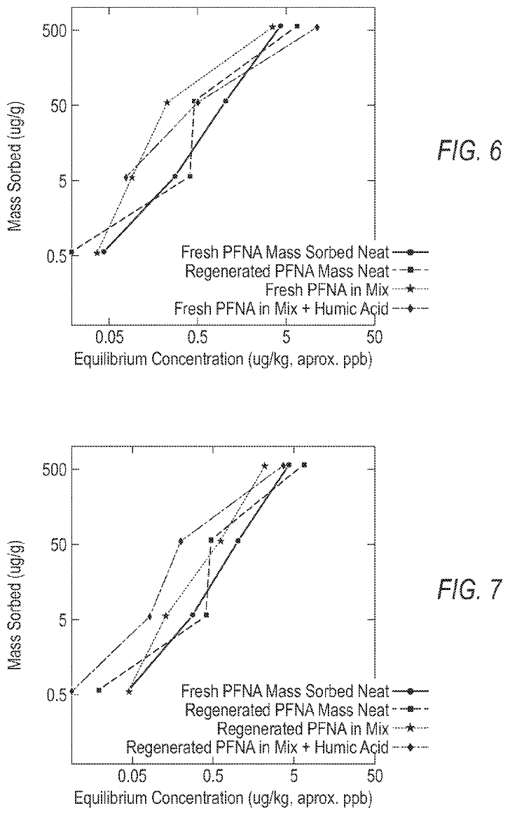

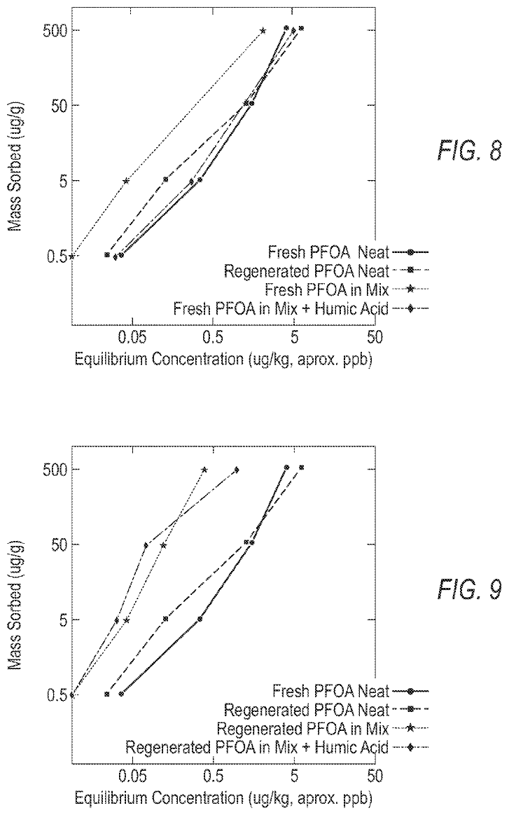

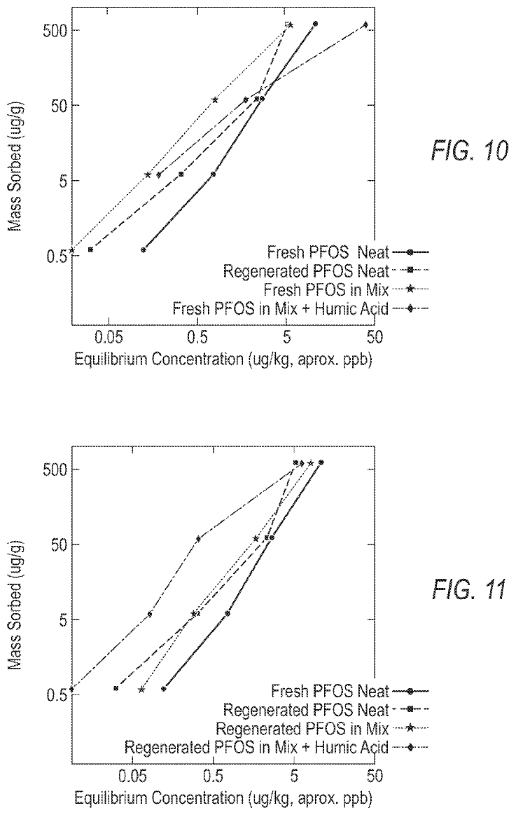

Results of absorption testing are shown in FIGS. 6-11. The carbon bed effectively captured PFOA, PFNA, and PFOS from the mixed contaminant solution both for fresh carbon samples and regenerated carbon samples. Capture was effective both in the presence and absence of humic acid. Thus, the regenerated system was effective for capturing mixed contaminants.

### Example 4: Column Testing

In view of the successful regeneration in Examples 1-3, column testing was performed to investigate a model column system with flow of contaminated solution and regeneration solution through the column.

A small column (10 cm tall×1.5 cm diameter) was loaded with freshly rinsed and dried GAC (14-15 g Calgon F400) as a capture bed. The capture bed was rinsed with DI water and then dosed with a 100 ppm PFOA solution. The filtrate was sampled every 3000 s until 31 samples were collected for producing a first curve of PFOA concentration in the filtrate. The dosing solution was pumped at a rate where the contact time was approximately 160 s and the column filtered 12-14 L until sampling was complete. Regeneration fluids were pumped through the column in order, with volumes chosen to be 50× or more of the free volume of the column. The first regeneration solution was a detergent solution of octanoic acid (0.2 g in 1 L DI water). The second regeneration solution was an aluminum hydroxide solution (320 g NaOH and 480 g Al(OH)₃ in 16 L DI water). The third regeneration solution was a calcium hydroxide solution (4 g Ca(OH)₂ in 2 L DI water). The fourth regeneration solution was a sodium hydroxide solution (4 g NaOH in 1 L DI water). Finally, the fifth regeneration solution was an acid wash solution (250 mL 12.39M HCl solution in 15.75 L DI water). Regeneration DI water was then pumped through the column until filtrate was pH>5. To produce the second curve for regenerated capture bed, the same procedure was followed for dosing with 100 ppm PFOA solution.

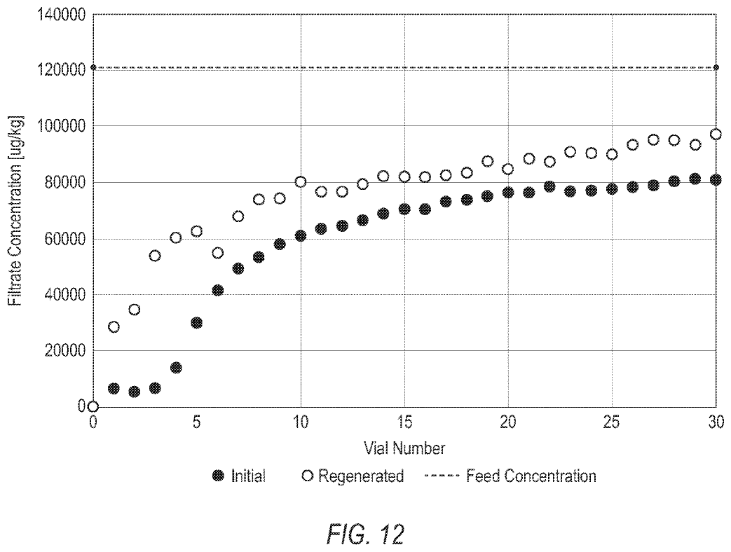

FIG. 12 shows the initial and regenerated breakthrough curves for the column filtering the 100 ppm PFOA feed solution. The feed concentration is shown as the dashed line. Early sample vials had low PFOA concentration, showing capture of PFOA on the carbon bed, although some PFOA is able to pass through the column even for early vials. The regeneration curve shows that the regenerated bed captured PFOA and closely followed the performance of the fresh bed with a slight decrease in capture rate.

A second separate experiment did not show the same regeneration effectiveness. It is hypothesized that the second experiment did not provide enough regeneration fluid to regenerate the column.

Thus, it is shown that the regeneration process can be effectively used in a column setup with flow of contaminated liquid through the column.

### Example 5: Regeneration Column Protocol

Overview: F400 granulated activated carbon (GAC) is saturated with PFAS, and upon saturation is referred to as “spent.” The spent F400 GAC is ground and packed into a commercial chromatography column. The column is then treated with NaOH and H₂O₂. After that, the column is further treated with two regeneration solutions in succession-first, Al₂(SO₄)₃ solution, then Ca(OH)₂ solution. Next, a dilute HCl solution is used to pull off other non-PFAS contaminants and to control the pH. Finally the GAC is rinsed with DI water. The rinsing steps are then repeated for the two regeneration solutions, the HCl solution, and the DI water.

A breakthrough curve is run to test the capacity of the regenerated column following the above rinsing steps. Column effluent and feed samples are collected and tested for PFAS concentrations. Column capacity is estimated via mass balance of the breakthrough curve and by the number of bed volumes treated prior to breakthrough upon reloading. Materials and Methods:

Preparation: A new econo-column (1×10 cm, BioRad 7374011) is rinsed with 50% ethanol and DI water. Bottom filter is inspected. 0.55 mm Zirconia/Silica beads are added to the bottom of the column to extend 2-3 cm above the bottom filter. Blender is rinsed with ethanol and water and filled with industrially loaded GAC. GAC is blended to reduce particle size and wet sieved through ASTM 60 and 80 mesh sieves. GAC is dried to obtain 60×80 mesh industrially loaded F400. 1.1 g of 60×80 mesh industrially loaded F400 is added to the column. Then, 0.5 mm Zirconia/Silica beads are added to fill up 1-2 cm above the F400 GAC. All materials are well packed in the column. A wetted piece of glass wool is added to the top of the beads and a flow adapter is installed to keep column contents in place. DI water is pumped through the column to allow F400 to wet.

Regeneration: 200 mL of 1M NaOH fluid is pumped through the column at 2.8 mL/min, followed by 200 mL of 12% food grade H₂O₂. Next, 2.5 L of 18.60 g/L Al₂(SO₄)₃ fluid is pumped through the column at 2.9 mL/min, followed by 2.5 L of a 4 g/L Ca(OH)₂ solution at the same rate. Next, 0.5 L of 0.1 M HCl solution is pumped through the column at 2.9 mL/min. Last, 4 L of DI water is pumped through the column at 2.9 mL/min to get the filtrate pH back up to 5. The rinsing with Al₂(SO₄)₃, Ca(OH)₂, HCl, and DI water is repeated with the same concentrations, volumes, and flow rates, except that 6 L of DI water is used.

Breakthrough Testing: The equivalent of 25,000 BVs, approximately 63 L, of contaminated water is pumped through the column at a rate of 2.9 mL/min, over about 16 days. Samples are taken at set intervals. Every 1000 BVs, a 46 mL sample is taken. 25 samples are taken in total.

### Example 6: Regeneration in Beaker

Unground spent F400 GAC was rinsed through a 80 mesh sieve to remove fines and dried for weighing, and 2 g were weighed and added to beaker. Another 2 g were weighed and set aside as control.

NaOH/H₂O₂ pre-rinse: 150 ml of 0.1 M NaOH solution was poured into beaker and swirled for 60 min. NaOH solution was poured off. 150 mL of 15 wt % H₂O₂ solution was poured on, swirled for 60 min, and poured off. This was referred to as the “pre-rinse.”

Regen: 500 mL of Regen Fluid 1 (4 g/L Ca(OH)₂ or 6 g/L CaCl₂)) was next poured into beaker. The beaker was shaken on the shaking table for 24 hours. Regen Fluid 1 was poured off. GAC in beaker was swirled with 500 mL of DI water and water was poured off. 500 mL of Regen Fluid 2 (12.83 g/L NaAl(OH)₄ or 18.6 g/L Al₂(SO₄)₃) was poured onto the GAC in the beaker. The beaker was shaken for 24 hours on the shaking table, then Regen Fluid 2 was poured off. 500 mL of DI water was added, swirled, and poured off.

Acid rinse: 500 mL of acid solution (0.01 M HCl solution or 0.005 M H₂SO₄ solution) was added and swirled for 60 minutes. The acid solution was poured off and pH was tested. Acid solution rinse was repeated until pH 3 or lower was reached. 500 mL of DI water was slowly poured on, swirled for 15 minutes, then poured off.

GAC from beaker was rinsed into test tubes. DI water was poured off and tubes were capped.

8 regenerated samples were tested along with the non-regenerated sample for characterization of PFAS compounds on the GAC before and after regeneration. The 8 runs were as follows:
1—no pre-rinse, HCl, Ca(OH)₂, NaAl(OH)₄
2—pre-rinse, HCl, Ca(OH)₂, Al₂(SO₄)₃
3—no pre-rinse, H₂SO₄, Ca(OH)₂, Al₂(SO₄)₃
4—pre-rinse, H₂SO₄, Ca(OH)₂, NaAl(OH)₄
5—no pre-rinse, HCl, CaCl₂, Al₂(SO₄)₃
6—pre-rinse, HCl, CaCl₂), NaAl(OH)₄
7—no pre-rinse, H₂SO₄, CaCl₂, NaAl(OH)₄
8—pre-rinse, H₂SO₄, CaCl₂, Al₂(SO₄)₃

Remaining GAC post regeneration was collected and placed in test tubes. PFAS was extracted from 100 mg of GAC by incubating each with 10 mL methanol for 24 h at 25 rpm, then applying 30 min of sonication. PFAS extracted from methanol was measured with LC-MS/MS. PFAS concentration was corrected for extraction efficiency by measuring the percent mass of the 1 ng PFAS isotope surrogates that were spiked prior to extraction then recovered in the extract.

### Results:

Table 12 shows the concentration of PFAS extracted from each GAC (μg/g).

TABLE 12

| | Condition | | | | | | | | | |
|---|---|---|---|---|---|---|---|---|---|---|
| Run # | PFBS | PFHxA | PFHpA | PFHxS | PFOA | PFOS | PFNA | PFDA | PFUnA | PFDoA |
| NonRegen | 0.032 | 1.330 | 0.879 | 0.034 | 1.725 | 0.098 | 0.219 | 0.089 | 0.013 | 0.003 |
| 1 | 0.027 | 0.818 | 0.490 | 0.017 | 1.045 | 0.059 | 0.143 | 0.067 | 0.009 | 0.003 |
| 2 | 0.007 | 0.674 | 0.382 | 0.005 | 0.637 | 0.015 | 0.073 | 0.025 | 0.003 | 0.001 |
| 3 | 0.024 | 1.130 | 0.665 | 0.016 | 1.210 | 0.035 | 0.137 | 0.033 | 0.006 | 0.001 |
| 4 | 0.022 | 0.826 | 0.490 | 0.016 | 1.030 | 0.060 | 0.147 | 0.062 | 0.012 | 0.003 |
| 5 | 0.012 | 0.889 | 0.506 | 0.007 | 1.220 | 0.015 | 0.070 | 0.025 | 0.003 | 0.001 |
| 6 | 0.045 | 1.100 | 0.650 | 0.024 | 2.430 | 0.079 | 0.190 | 0.065 | 0.008 | 0.002 |
| 7 | 0.021 | 1.150 | 0.767 | 0.016 | 2.010 | 0.069 | 0.295 | 0.114 | 0.014 | 0.003 |
| 8 | 0.027 | 1.160 | 0.694 | 0.015 | 1.680 | 0.031 | 0.106 | 0.034 | 0.004 | 0.001 |

Table 13 shows the change in PFAS concentration by each process (μg/g). These values were calculated by subtracting the concentration on the non-regenerated GAC from the concentration on the regenerated GAC. Negative values indicate a decrease in PFAS concentration. All runs except 6 and 7 removed PFAS overall, showing that the regeneration processes used were able to remove PFAS from industry GAC. Runs 6 and 7 increased in some of the PFAS compounds detected (large spike in PFOA and small increase in PFBS for 6, while 7 had a large spike in PFOA and a spike in PFNA and in PFDA) as compared to the amounts extracted from the control. Both of these runs used CaCl₂) and NaAl(OH)₄. Run 2, which used Ca(OH)₂ and Al₂(SO₄)₃, performed the best out of these regeneration methods, indicating that the use of Ca(OH)₂ and Al₂(SO₄)₃ improved performance. The increase in PFOA may have been the result of contamination, as PFOA was frequently used in the lab.

TABLE 13

| | | | | | | | | | | | Total |
|---|---|---|---|---|---|---|---|---|---|---|---|
| # | PFBS | PFHxA | PFHpA | PFHxS | PFOA | PFOS | PFNA | PFDA | PFUnA | PFDoA | PFAS |
| 1 | −0.005 | −0.512 | −0.389 | −0.017 | −0.680 | −0.039 | −0.077 | −0.022 | −0.004 | −0.001 | −1.747 |
| 2 | −0.025 | −0.656 | −0.496 | −0.030 | −1.088 | −0.083 | −0.146 | −0.064 | −0.010 | −0.002 | −2.601 |
| 3 | −0.008 | −0.200 | −0.214 | −0.019 | −0.515 | −0.063 | −0.083 | −0.056 | −0.008 | −0.002 | −1.167 |
| 4 | −0.010 | −0.504 | −0.388 | −0.018 | −0.695 | −0.038 | −0.072 | −0.027 | −0.001 | 0.000 | −1.756 |
| 5 | −0.020 | −0.441 | −0.372 | −0.028 | −0.505 | −0.082 | −0.149 | −0.064 | −0.010 | −0.002 | −1.674 |
| 6 | 0.013 | −0.230 | −0.229 | −0.011 | 0.705 | −0.019 | −0.029 | −0.024 | −0.005 | −0.001 | 0.170 |
| 7 | −0.011 | −0.180 | −0.112 | −0.019 | 0.285 | −0.029 | 0.076 | 0.025 | 0.000 | 0.000 | 0.035 |
| 8 | −0.005 | −0.170 | −0.184 | −0.019 | −0.045 | −0.066 | −0.113 | −0.055 | −0.010 | −0.002 | −0.670 |

Table 14 shows the percent change in PFAS concentration by each process, as calculated by dividing the concentration change for each process by the initial concentration, then multiplying by 100. Overall, regeneration removed PFAS from GAC, with similar results across compounds.

TABLE 14

| | | | | | | | | | | | Total |
|---|---|---|---|---|---|---|---|---|---|---|---|
| # | PFBS | PFHxA | PFHpA | PFHxS | PFOA | PFOS | PFNA | PFDA | PFUnA | PFDoA | PFAS |
| 1 | −16.88 | −38.51 | −44.27 | −50.34 | −39.42 | −39.84 | −34.99 | −25.11 | −30.21 | −23.05 | −39.49 |
| 2 | −78.13 | −49.32 | −56.51 | −85.97 | −63.07 | −84.85 | −66.53 | −71.61 | −75.35 | −69.95 | −58.79 |
| 3 | −25.73 | −15.04 | −24.33 | −54.09 | −29.86 | −64.38 | −37.74 | −62.59 | −57.22 | −69.74 | −26.39 |
| 4 | −30.96 | −37.89 | −44.22 | −53.81 | −40.29 | −39.01 | −32.94 | −30.83 | −11.18 | −11.49 | −39.69 |
| 5 | −61.85 | −33.16 | −42.38 | −80.35 | −29.28 | −84.21 | −67.95 | −71.60 | −76.79 | −69.34 | −37.84 |
| 6 | 39.16 | −17.26 | −26.06 | −31.22 | 40.87 | −19.37 | −13.21 | −27.43 | −39.27 | −38.24 | 3.83 |
| 7 | −34.98 | −13.53 | −12.72 | −54.57 | 16.52 | −29.25 | 34.64 | 27.53 | 2.21 | −1.05 | 0.80 |
| 8 | −16.14 | −12.78 | −20.96 | −55.86 | −2.61 | −67.84 | −51.51 | −61.74 | −71.22 | −72.03 | −15.15 |

Table 15 shows the average concentration change (μg/g) for each condition. Values were calculated by averaging the concentration change due to regeneration for all the runs that had the condition listed for each variable. Negative values indicate removals of PFAS on average for the particular condition listed for each variable. Overall, PFAS was removed on average for all conditions, with only PFOA increasing for the CaCl₂) condition.

TABLE 15

| Variable | Condition | PFBS | PFHxA | PFHpA | PFHxS | PFOA | PFOS |
|---|---|---|---|---|---|---|---|
| Peroxide Pre | Pre Rinse | −0.007 | −0.390 | −0.325 | −0.019 | −0.281 | −0.052 |
| Rinse | No Pre Rinse | −0.011 | −0.333 | −0.272 | −0.021 | −0.354 | −0.053 |
| Acid Used | H2SO4 | −0.009 | −0.263 | −0.225 | −0.019 | −0.243 | −0.049 |
| | HCl | −0.010 | −0.460 | −0.372 | −0.021 | −0.392 | −0.056 |
| Calcium Regen | CaCl2 | −0.006 | −0.255 | −0.224 | −0.019 | 0.110 | −0.049 |
| Fluid Used | Ca(OH)2 | −0.012 | −0.468 | −0.372 | −0.021 | −0.744 | −0.056 |
| Aluminum Regen | Al2(SO4)3 | −0.015 | −0.367 | −0.317 | −0.024 | −0.538 | −0.074 |
| Fluid Used | NaAl(OH)4 | −0.004 | −0.356 | −0.280 | −0.016 | −0.096 | −0.031 |

| Variable | Condition | PFNA | PFDA | PFUnA | PFDoA | Total PFAS |
|---|---|---|---|---|---|---|
| Peroxide Pre | Pre Rinse | −0.090 | −0.043 | −0.007 | −0.002 | −1.214 |
| Rinse | No Pre Rinse | −0.058 | −0.029 | −0.005 | −0.001 | −1.138 |
| Acid Used | H2SO4 | −0.048 | −0.028 | −0.005 | −0.001 | −0.889 |
| | HCl | −0.100 | −0.044 | −0.007 | −0.002 | −1.463 |
| Calcium Regen | CaCl2 | −0.054 | −0.030 | −0.006 | −0.002 | −0.535 |
| Fluid Used | Ca(OH)2 | −0.094 | −0.042 | −0.006 | −0.002 | −1.818 |
| Aluminum Regen | Al2(SO4)3 | −0.123 | −0.060 | −0.009 | −0.002 | −1.528 |
| Fluid Used | NaAl(OH)4 | −0.025 | −0.012 | −0.003 | −0.001 | −0.824 |

Table 16 shows the average percent concentration change for each condition. Values were calculated by averaging the concentration change due to regeneration for all the runs that had the condition listed for each variable, then multiplying by 100 and dividing by the non-regenerated concentration. Negative values indicate removals of PFAS on average for the particular condition listed for each variable. Overall, PFAS was removed on average for all conditions, with only PFOA slightly increasing for the CaCl₂) condition.

TABLE 16

| Variable | Condition | PFBS | PFHxA | PFHpA | PFHxS | PFOA | PFOS |
|---|---|---|---|---|---|---|---|
| Peroxide Pre | Pre Rinse | −21.516 | −29.314 | −36.938 | −56.715 | −16.275 | −52.768 |
| Rinse | No Pre Rinse | −34.860 | −25.061 | −30.926 | −59.837 | −20.507 | −54.419 |
| Acid Used | H2SO4 | −26.950 | −19.810 | −25.558 | −54.584 | −14.058 | −50.120 |
| | HCl | −29.426 | −34.565 | −42.305 | −61.969 | −22.724 | −57.067 |
| Calcium Regen | CaCl2 | −18.453 | −19.185 | −25.530 | −55.499 | 6.377 | −50.165 |
| Fluid Used | Ca(OH)2 | −37.923 | −35.190 | −42.333 | −61.054 | −43.159 | −57.022 |
| Aluminum Regen | Al2(SO4)3 | −45.461 | −27.575 | −36.047 | −69.069 | −31.202 | −75.319 |
| Fluid Used | NaAl(OH)4 | −10.915 | −26.799 | −31.816 | −47.484 | −5.580 | −31.868 |

| Variable | Condition | PFNA | PFDA | PFUnA | PFDoA | Total PFAS |
|---|---|---|---|---|---|---|
| Peroxide Pre | Pre Rinse | −41.049 | −47.900 | −49.254 | −47.930 | −27.448 |
| Rinse | No Pre Rinse | −26.509 | −32.942 | −40.502 | −40.796 | −25.731 |
| Acid Used | H2SO4 | −21.890 | −31.905 | −34.350 | −38.578 | −20.107 |
| | HCl | −45.668 | −48.937 | −55.406 | −50.147 | −33.073 |
| Calcium Regen | CaCl2 | −24.507 | −33.311 | −46.268 | −45.167 | −12.089 |
| Fluid Used | Ca(OH)2 | −43.051 | −47.531 | −43.488 | −43.559 | −41.090 |
| Aluminum Regen | Al2(SO4)3 | −55.933 | −66.883 | −70.145 | −70.265 | −34.542 |
| Fluid Used | NaAl(OH)4 | −11.625 | −13.959 | −19.611 | −18.460 | −18.638 |

### Example 7: Regeneration and Pretreatment in Column

Three columns loaded with GAC were prepared for breakthrough testing. A first column was loaded with previously unused GAC (“fresh GAC”). A second column was loaded with GAC that was saturated with PFAS/contaminants and regenerated (“spent GAC”). A third column was loaded with GAC that was unused, but which had been rinsed using the regeneration process (“pretreated GAC”).

Materials. Calgon F400 GAC was used in this study. Spent GAC was used to capture contaminants at a waste water treatment facility until saturated. The GAC was 60×80 mesh sieved. A carbon bed, made from the GAC, was installed in a column. The flow rate was set to 2.9 mL/min. Column ID: 1 cm. Bed height: 3-3.2 cm. Bed weight: 1.1-1.15 g.

Pretreatment of fresh GAC was performed according to the following protocol. Take the econo-column and rinse with 50% ethanol and DI water. Rinse with DI water. Verify that the bottom filter is intact. Fill the column with water and close the bottom valve. Pour 0.5 mm Zirconia/Silica beads to the bottom of the column such that the beads extend 2-3 cm above the bottom filter. Tap gently to ensure the beads are well packed, then open the valve at the column bottom to drain water. Rinse a blender with ethanol and water then fill it with fresh F400 GAC. Blend GAC and wet sieve through ASTM 60 and 80 mesh sieves. Dry 80 mesh sieve to obtain 60×80 mesh fresh F400. Add ˜1.1 g of 60×80 mesh fresh F400 into the column (using ethanol rinsed spatula). The column should be 3 cm tall. Use a syringe to push water up from the bottom of the column, tapping to ensure good packing of the GAC. Continue tapping and flushing with water until air bubbles cease. Push water to 2 cm above the GAC. Add enough 0.5 mm Zirconia/Silica beads to fill up 1-2 cm above the PAC. Tap gently to ensure the beads are well packed. Add a wetted piece of glass wool to the top of the Zirconia/Silica beads and then install the flow adapter to keep the contents of the column in place. Pump DI water through the column and allow F400 to wet for several hours. Pump 250 mL of 1M NaOH fluid through the column at 2.8 mL/min, followed by 250 ml of 12% food grade H₂O₂. Next, pump 2.5 L of 20 g/l Al(OH)₃/10 g/L NaOH fluid through the column at 2.9 mL/min, followed by 2.5 L of a 4 g/L Ca(OH)₂ solution at the same rate. Next, pump 0.5 L of 0.1M HCl solution through the column at 2.9 mL/min. Finally, pump 2.5 L of DI water through the column at 2.9 mL/min. Repeat the regeneration rinse (Al(OH)₃, NaOH, and Ca(OH)₂), HCl rinse, and DI water rinse, with the volume of DI water in the final rinse increased to 6 L.

Regeneration of spent GAC was performed according to essentially the same protocol as the pretreatment protocol, but with the carbon being spent GAC, instead of fresh GAC.

Columns of regenerated spent GAC, fresh GAC, and pretreated GAC were pumped with facility water for approximately 20,000 BVs, with samples taken about every 1,000 BVs (approximately 2500 mL).

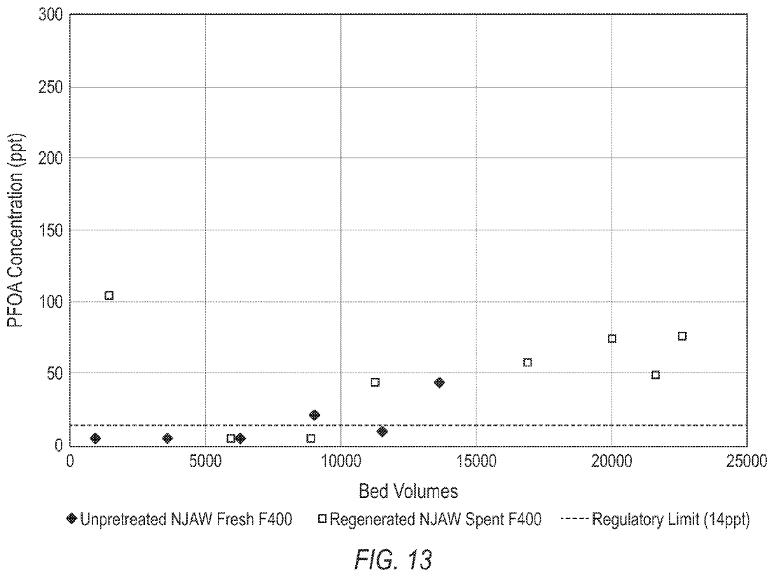

FIG. 13 shows the performance of the regenerated GAC column compared to the fresh GAC column, using PFOA as a representative PFAS compound.

It is estimated that the regenerated spent GAC column breaks through the regulatory limit (14 ppt) after 9650 BVs of field site water has passed through the column. The fresh GAC column, the breakthrough point happens after 12450 BVs. The recover capacity is therefore calculated as 77%.

Columns of Lab F400 and fresh GAC were pretreated according to the regeneration process. The pretreated columns were loaded with facility water for approximately 20,000 BVs, with samples taken every 1,000 BVs.

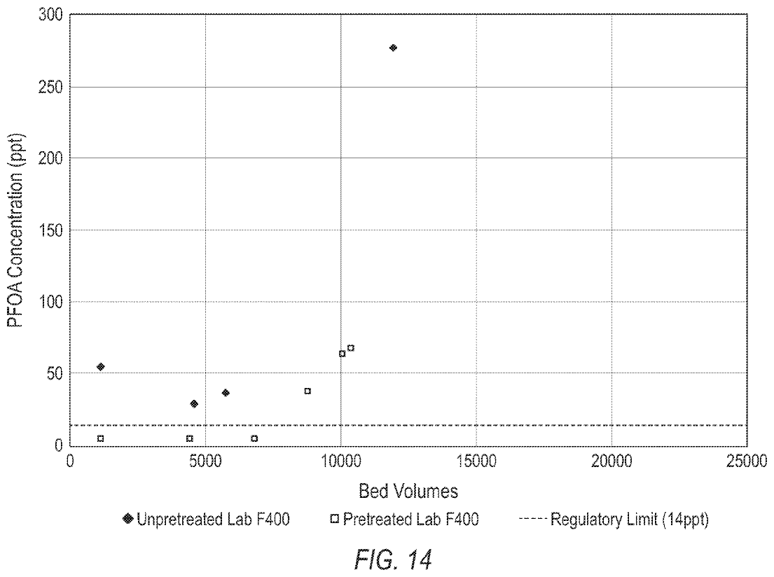

FIG. 14 shows the performance of pretreated F400 GAC column to an unpretreated F400 GAC column, using PFOA as the representative PFAS compound.

The pretreated column breaks through at about 7400 BVs, while the unpretreated column showed breakthrough at 1150 BVs. Due to apparatus differences, these results are not directly comparable to the regeneration results in FIG. 13.

### Example 8: Regeneration with Surfactants and Agglomerating Agents

To examine whether emulsions of surfactants and agglomerating agents aid regeneration efficiency, thirteen (13) fluids were prepared as set forth in Table 17. Surfactants used included sodium dodecyl sulfate (SDS) and sorbitan monolaurate (Span 20). Agglomerating agents used included canola oil and safflower oil.

TABLE 17
Fluids of Example 7

| Fluid # | Composition |
|---|---|
| Fluid 1 (F1) | 10 L of 1 wt % Span 20 and 1 wt % Glycerol |
| Fluid 2 (F2) | 10 L of 1 wt % SDS and 1 wt % Glycerol |
| Fluid 3 (F3) | 2 L 0.1M NaOH |
| Fluid 4 (F4) | 2 L of 6% H₂O₂ |
| Fluid 5 (F5) | 4 L of 0.001M HCl |
| Regen Mix 1 | 500 mL of 0.3 wt % Span 20, 10 wt % Safflower oil, |
| (RM1) | 1.4 g/L Ca(OH)₂ and 4.49 g/L NaAl(OH)₄, and 0.3 wt % |
| | Glycerol |
| Regen Mix 2 | 500 ml of 10 wt % SDS, 10 wt % Safflower oil, 0.14 |
| (RM2) | g/L Ca(OH)₂ and 0.449 g/L NaAl(OH)₄, and 0.3 wt % |
| | Glycerol |
| Regen Mix 3 | 500 ml of 10 wt % Span 20, 10 wt % Canola oil, 1.4 |
| (RM3) | g/L Ca(OH)₂ and 4.49 g/L NaAl(OH)₄, and 0.3 wt % |
| | Glycerol |
| Regen Mix 4 | 500 ml of 0.3 wt % SDS, 10 wt % Canola oil, 0.14 |
| (RM4) | g/L Ca(OH)₂ and 0.449 g/L NaAl(OH)4, and 0.3 wt % |
| | Glycerol |
| Regen Mix 5 | 500 ml of 0.3 wt % Span 20, 4.5 wt % Safflower |
| (RM5) | oil, 0.14 g/L Ca(OH)₂ and 0.449 g/L NaAl(OH)₄, |
| | and 0.3 wt % Glycerol |
| Regen Mix 6 | 500 ml of 10 wt % SDS, 4.5 wt % Safflower oil, |
| (RM6) | 1.4 g/L Ca(OH)₂ and 4.49 g/L NaAl(OH)₄, and 0.3 |
| | wt % Glycerol |
| Regen Mix 7 | 500 ml of 10 wt % Span 20, 4.5 wt % Canola oil, |
| (RM7) | 0.14 g/L Ca(OH)₂ and 0.449 g/L NaAl(OH)₄, and |
| | 0.3 wt % Glycerol |
| Regen Mix 7 | 500 ml of 0.3 wt % SDS, 4.5 wt % Canola oil, 1.4 |
| (RM8) | g/L Ca(OH)₂ and 4.49 g/L NaAl(OH)₄, and 0.3 wt % |
| | Glycerol |

Spent F400 GAC from was grounded in an EtOH and deionized (DI) water rinsed blender. The grounded GAC was then rinsed through ASTM 60 and 80 mesh sieves, dried in an oven at approximately 80° C., and collected in a centrifuge tube.

Nine (9) test tubes and caps were rinsed with EtOH followed by DI water and the tubes were allowed to dry. 0.5 g of the prepared 60×80 mesh GAC was added into each of eight (8) cleaned 1 L erlenmeyer flasks and one of the test tubes.

Designated amounts of the fluids set forth in Table 17 were added to the flasks containing 60×80 mesh GAC in the order set forth in Table 18. Each fluid was incubated at 150 rpm on a shaker for the time specified in Table 18. For NaOH, H₂O₂, soaps, HCl, and DI water, plastic graduated cylinders were used for measurements. The soaps were swirled gently to mix without forming bubbles prior to measurement. The regeneration mixes (i.e., RM1-8) were shaken and poured into the flask (i.e., all 500 mL of each regeneration mix was poured into the flask). Another rinse was added after Rinse 10 wherein 200 mL of soap and 300 mL of DI water were added and incubated at 150 rpm for 18 hours (h).

TABLE 18
Rinse Order

| | Run 1 | Run 2 | Run 3 | Run 4 | Run 5 | Run 6 | Run 7 | Run 8 |
|---|---|---|---|---|---|---|---|---|
| Rinse 1 | 200 mL | 200 mL | 200 mL | 200 mL | 200 mL | 200 mL | 200 mL | 200 mL |
| (1 h) | F3 | F3 | F3 | F3 | F3 | F3 | F3 | F3 |
| Rinse 2 | 150 mL | 150 mL | 150 mL | 150 mL | 150 mL | 150 mL | 150 mL | 150 mL |
| (1 h) | F4 | F4 | F4 | F4 | F4 | F4 | F4 | F4 |
| Rinse 3 | 500 mL | 500 mL | 500 mL | 500 mL | 500 mL | 500 mL | 500 mL | 500 mL |
| (103 h) | RM1 | RM2 | RM3 | RM4 | RM5 | RM6 | RM7 | RM8 |
| Rinse 4 | 500 mL | 500 mL | 500 mL | 500 mL | 500 mL | 500 mL | 500 mL | 500 mL |
| (1 h) | Soap | Soap | Soap | Soap | Soap | Soap | Soap | Soap |
| Rinse 5 | 500 mL | 500 mL | 500 mL | 500 mL | 500 mL | 500 mL | 500 mL | 500 mL |
| (1 h) | Soap | Soap | Soap | Soap | Soap | Soap | Soap | Soap |
| Rinse 6 | 500 mL | 500 mL | 500 mL | 500 mL | 500 mL | 500 mL | 500 mL | 500 mL |
| (1 h) | DI | DI | DI | DI | DI | DI | DI | DI |
| | water | water | water | water | water | water | water | water |
| Rinse 7 | 500 mL | 500 mL | 500 mL | 500 mL | 500 mL | 500 mL | 500 mL | 500 mL |
| (1 h) | Soap | Soap | Soap | Soap | Soap | Soap | Soap | Soap |
| Rinse 8 | 500 mL | 500 mL | 500 mL | 500 mL | 500 mL | 500 mL | 500 mL | 500 mL |
| (24 h) | Soap | Soap | Soap | Soap | Soap | Soap | Soap | Soap |
| Rinse 9 | 500 mL | 500 mL | 500 mL | 500 mL | 500 mL | 500 mL | 500 mL | 500 mL |
| (1 h) | DI | DI | DI | DI | DI | DI | DI | DI |
| | water | water | water | water | water | water | water | water |
| Rinse 10 | 300 mL | 300 mL | 300 mL | 300 mL | 300 mL | 300 mL | 300 mL | 300 mL |
| (3 h) | Soap | Soap | Soap | Soap | Soap | Soap | Soap | Soap |
| Rinse 11 | 300 mL | 300 mL | 300 mL | 300 mL | 300 mL | 300 mL | 300 mL | 300 mL |
| (3 h) | Soap | Soap | Soap | Soap | Soap | Soap | Soap | Soap |
| Rinse 12 | 500 mL | 500 mL | 500 mL | 500 mL | 500 mL | 500 mL | 500 mL | 500 mL |
| (3 h) | 17.4% | 17.4% | 17.4% | 17.4% | 17.4% | 17.4% | 17.4% | 17.4% |
| | conc. | conc. | conc. | conc. | conc. | conc. | conc. | conc. |
| | Soap | Soap | Soap | Soap | Soap | Soap | Soap | Soap |
| Rinse 13 | 500 mL | 500 mL | 500 mL | 500 mL | 500 mL | 500 mL | 500 mL | 500 mL |
| (3 h) | 50% | 50% | 50% | 50% | 50% | 50% | 50% | 50% |
| | conc. | conc. | conc. | conc. | conc. | conc. | conc. | conc. |
| | Soap | Soap | Soap | Soap | Soap | Soap | Soap | Soap |
| Rinse 14 | 500 mL | 500 mL | 500 mL | 500 mL | 500 mL | 500 mL | 500 mL | 500 mL |
| (3 h) | Soap | Soap | Soap | Soap | Soap | Soap | Soap | Soap |
| Rinse 15 | 500 mL | 500 mL | 500 mL | 500 mL | 500 mL | 500 mL | 500 mL | 500 mL |
| (1 h) | DI | DI | DI | DI | DI | DI | DI | DI |
| | water | water | water | water | water | water | water | water |
| Rinse 16 | 500 mL | 500 mL | 500 mL | 500 mL | 500 mL | 500 mL | 500 mL | 500 mL |
| (72 h) | Soap | Soap | Soap | Soap | Soap | Soap | Soap | Soap |
| Rinse 17 | 500 mL | 500 mL | 500 mL | 500 mL | 500 mL | 500 mL | 500 mL | 500 mL |
| (1 h) | DI | DI | DI | DI | DI | DI | DI | DI |
| | water | water | water | water | water | water | water | water |
| Rinse 18 | 200 mL | 200 mL | 200 mL | 200 mL | 200 mL | 200 mL | 200 mL | 200 mL |
| (23 h + | Soap | Soap | Soap | Soap | Soap | Soap | Soap | Soap |
| hand shake) | | | | | | | | |
| Rinse 19 | 500 mL | 500 mL | 500 mL | 500 mL | 500 mL | 500 mL | 500 mL | 500 mL |
| (18 h) | DI | DI | DI | DI | DI | DI | DI | DI |
| | water | water | water | water | water | water | water | water |
| Rinse 20 | 500 mL | 500 mL | 500 mL | 500 mL | 500 mL | 500 mL | 500 mL | 500 mL |
| (1 h) | DI | DI | DI | DI | DI | DI | DI | DI |
| | water | water | water | water | water | water | water | water |
| Rinse 21 | 500 mL | 500 mL | 500 mL | 500 mL | 500 mL | 500 mL | 500 mL | 500 mL |
| (18 h) | DI | DI | DI | DI | DI | DI | DI | DI |
| | water | water | water | water | water | water | water | water |
| Rinse 22 | 250 mL | 250 mL | 250 mL | 250 mL | 250 mL | 250 mL | 250 mL | 250 mL |
| (1 h) | DI | DI | DI | DI | DI | DI | DI | DI |
| | water | water | water | water | water | water | water | water |
| Rinse 23 | 250 mL | 250 mL | 250 mL | 250 mL | 250 mL | 250 mL | 250 mL | 250 mL |
| (1 h) | DI | DI | DI | DI | DI | DI | DI | DI |
| | water | water | water | water | water | water | water | water |
| Rinse 24 | 500 mL | 500 mL | 500 mL | 500 mL | 500 mL | 500 mL | 500 mL | 500 mL |
| (1 h) | F5 | F5 | F5 | F5 | F5 | F5 | F5 | F5 |
| Rinse 25 | 500 mL | 500 mL | 500 mL | 500 mL | 500 mL | 500 mL | 500 mL | 500 mL |
| (1 h) | DI | DI | DI | DI | DI | DI | DI | DI |
| | water | water | water | water | water | water | water | water |

### Results:

Concentration of PFAS extracted from each GAC (μg/g) are set forth in Table 19. The PFAS mass extracted from each sample was divided by GAC mass recovered from each run. Remaining GAC after each run was collected and placed in test tubes. PFAS was extracted from GAC by incubating each with 10 mL methanol for 24 h at 25 rpm, then applying 15 min of sonication. PFAS extracted from methanol was measured with LC-MS/MS. These values are uncorrected for extraction efficiency.

TABLE 19
Concentration of PFAS extracted from GAC after Runs 1-8 and without Regeneration.

| | Run 1 | Run 2 | Run 3 | Run 4 | Run 5 | Run 6 | Run 7 | Run 8 | No Regeneration |
|---|---|---|---|---|---|---|---|---|---|
| PFBA | 0.000 | 0.019 | 0.030 | 0.003 | 0.003 | 0.030 | 0.009 | 0.010 | 0.163 |
| PFPeA | 0.004 | 0.059 | 0.038 | 0.005 | 0.005 | 0.073 | 0.002 | 0.042 | 0.517 |
| PFBS | 0.001 | 0.000 | 0.000 | 0.001 | 0.000 | 0.002 | 0.005 | 0.000 | 0.019 |
| 4-2FTS | 0.002 | 0.010 | 0.004 | 0.002 | 0.002 | 0.013 | 0.001 | 0.008 | 0.103 |
| PFHxA | 0.014 | 0.107 | 0.078 | 0.013 | 0.012 | 0.117 | 0.022 | 0.076 | 1.150 |
| PFHpA | 0.015 | 0.080 | 0.057 | 0.007 | 0.013 | 0.091 | 0.021 | 0.045 | 0.890 |
| PFHxS | 0.011 | 0.028 | 0.037 | 0.020 | 0.013 | 0.031 | 0.025 | 0.022 | 0.260 |
| 6-2FTS | 0.434 | 0.610 | 0.454 | 0.162 | 0.363 | 0.769 | 0.566 | 0.511 | 7.880 |
| PFOA | 0.316 | 0.765 | 0.536 | 0.132 | 0.277 | 0.947 | 0.398 | 0.484 | 6.920 |
| PFHpS | 0.000 | 0.002 | 0.000 | 0.000 | 0.000 | 0.001 | 0.002 | 0.000 | 0.011 |
| PFOS | 0.049 | 0.066 | 0.057 | 0.049 | 0.080 | 0.077 | 0.085 | 0.049 | 0.625 |
| PFNA | 0.014 | 0.026 | 0.018 | 0.009 | 0.014 | 0.032 | 0.016 | 0.013 | 0.2525 |
| 8-2FTS | 0.094 | 0.063 | 0.068 | 0.048 | 0.112 | 0.081 | 0.153 | 0.054 | 0.6085 |
| PFDA | 0.002 | 0.002 | 0.000 | 0.001 | 0.000 | 0.001 | 0.001 | 0.000 | 0.01 |
| Total | 0.956 | 1.837 | 1.377 | 0.452 | 0.894 | 2.265 | 1.306 | 1.314 | 19.408 |
| PFAS | | | | | | | | | |

Change in PFAS concentration by each process (μg/g) is set forth in Table 20. These values were calculated by subtracting the concentration on the non-regenerated GAC from the concentration on the regenerated GAC. Negative values indicate a decrease in PFAS concentration.

TABLE 20
Change in PFAS concentration by each process (ug/g)

| | Run 1 | Run 2 | Run 3 | Run 4 | Run 5 | Run 6 | Run 7 | Run 8 |
|---|---|---|---|---|---|---|---|---|
| PFBA | −0.1630 | −0.1440 | −0.1330 | −0.1600 | −0.1600 | −0.1330 | −0.1540 | −0.1530 |
| PFPeA | −0.5125 | −0.4575 | −0.4785 | −0.5115 | −0.5115 | −0.4435 | −0.5145 | −0.4745 |
| PFBS | −0.0175 | −0.0185 | −0.0185 | −0.0175 | −0.0185 | −0.0165 | −0.0135 | −0.0185 |
| 4-2FTS | −0.1010 | −0.0930 | −0.0990 | −0.1010 | −0.1010 | −0.0900 | −0.1020 | −0.0950 |
| PFHxA | −1.1360 | −1.0430 | −1.0720 | −1.1370 | −1.1380 | −1.0330 | −1.1280 | −1.0740 |
| PFHpA | −0.8750 | −0.8100 | −0.8330 | −0.8830 | −0.8770 | −0.7990 | −0.8690 | −0.8450 |
| PFHxS | −0.2485 | −0.2315 | −0.2225 | −0.2395 | −0.2465 | −0.2285 | −0.2345 | −0.2375 |
| 6-2FTS | −7.4460 | −7.2700 | −7.4260 | −7.7180 | −7.5170 | −7.1110 | −7.3140 | −7.3690 |
| PFOA | −6.6040 | −6.1550 | −6.3840 | −6.7880 | −6.6430 | −5.9730 | −6.5220 | −6.4360 |
| PFHpS | −0.0110 | −0.0090 | −0.0110 | −0.0110 | −0.0110 | −0.0100 | −0.0090 | −0.0110 |
| PFOS | −0.5760 | −0.5590 | −0.5680 | −0.5760 | −0.5450 | −0.5480 | −0.5400 | −0.5760 |
| PFNA | −0.2385 | −0.2265 | −0.2345 | −0.2435 | −0.2385 | −0.2205 | −0.2365 | −0.2395 |
| 8-2FTS | −0.5145 | −0.5455 | −0.5405 | −0.5605 | −0.4965 | −0.5275 | −0.4555 | −0.5545 |
| PFDA | −0.0080 | −0.0080 | −0.0100 | −0.0090 | −0.0100 | −0.0090 | −0.0090 | −0.0100 |
| Total | −18.45 | −17.57 | −18.03 | −18.96 | −18.51 | −17.14 | −18.10 | −18.09 |
| PFAS | | | | | | | | |

All runs removed PFAS overall, showing that the regeneration processes used were able to remove PFAS from spent GAC.

Percent change in PFAS concentration by each process is set forth in Table 21. The percent change was calculated by dividing the concentration change for each process by the initial concentration, then multiplying by 100. Negative values indicate a decrease in PFAS concentration.

TABLE 20
Percent change in PFAS concentration by each process (ug/g)

| | Run 1 | Run 2 | Run 3 | Run 4 | Run 5 | Run 6 | Run 7 | Run 8 |
|---|---|---|---|---|---|---|---|---|
| PFBA | −100.00 | −88.34 | −81.60 | −98.16 | −98.16 | −81.60 | −94.48 | −93.87 |
| PFPeA | −99.23 | −88.58 | −92.64 | −99.03 | −99.03 | −85.87 | −99.61 | −91.87 |
| PFBS | −94.59 | −100.00 | −100.00 | −94.59 | −100.00 | −89.19 | −72.97 | −100.00 |
| 4-2FTS | −98.06 | −90.29 | −96.12 | −98.06 | −98.06 | −87.38 | −99.03 | −92.23 |
| PFHxA | −98.78 | −90.70 | −93.22 | −98.87 | −98.96 | −89.83 | −98.09 | −93.39 |
| PFHpA | −98.31 | −91.01 | −93.60 | −99.21 | −98.54 | −89.78 | −97.64 | −94.94 |
| PFHxS | −95.76 | −89.21 | −85.74 | −92.29 | −94.99 | −88.05 | −90.37 | −91.52 |
| 6-2FTS | −94.49 | −92.26 | −94.24 | −97.94 | −95.39 | −90.24 | −92.82 | −93.52 |
| PFOA | −95.43 | −88.95 | −92.25 | −98.09 | −96.00 | −86.32 | −94.25 | −93.01 |
| PFHpS | −100.00 | −81.82 | −100.00 | −100.00 | −100.00 | −90.91 | −81.82 | −100.00 |
| PFOS | −92.16 | −89.44 | −90.88 | −92.16 | −87.20 | −87.68 | −86.40 | −92.16 |
| PFNA | −94.46 | −89.70 | −92.87 | −96.44 | −94.46 | −87.33 | −93.66 | −94.85 |
| 8-2FTS | −84.55 | −89.65 | −88.82 | −92.11 | −81.59 | −86.69 | −74.86 | −91.13 |
| PFDA | −80.00 | −80.00 | −100.00 | −90.00 | −100.00 | −90.00 | −90.00 | −100.00 |
| Total | −95.07 | −90.53 | −92.90 | −97.67 | −95.39 | −88.33 | −93.27 | −93.23 |
| PFAS | | | | | | | | |

Average percent concentration change (μg/g) for each condition is set forth in Table 21. Values were calculated by averaging the concentration change due to regeneration for all the runs that had the condition listed for each variable, then multiplying by 100 and dividing by the non-regenerated concentration. Negative values indicate removals of PFAS on average for the particular condition listed for each variable.

TABLE 21
Change in PFAS concentration by each process (ug/g)

| | Surfactant | | Oil | | Oil Wt % | | Surfactant Wt % | |
|---|---|---|---|---|---|---|---|---|
| | SDS | Span 20 | Canola | Safflower | 4.5 | 10 | 0.3 | 10 |
| PFBA | −90.49 | −93.56 | −92.02 | −92.02 | −92.02 | −92.02 | −97.55 | −86.50 |
| PFPeA | −91.34 | −97.63 | −95.79 | −93.18 | −94.09 | −94.87 | −97.29 | −91.67 |
| PFBS | −95.95 | −91.89 | −91.89 | −95.95 | −90.54 | −97.30 | −97.30 | −90.54 |
| 4-2FTS | −91.99 | −97.82 | −96.36 | −93.45 | −94.17 | −95.63 | −96.60 | −93.20 |
| PFHxA | −93.20 | −97.26 | −95.89 | −94.57 | −95.07 | −95.39 | −97.50 | −92.96 |
| PFHpA | −93.74 | −97.02 | −96.35 | −94.41 | −95.22 | −95.53 | −97.75 | −93.01 |
| PFHxS | −90.27 | −91.71 | −89.98 | −92.00 | −91.23 | −90.75 | −93.64 | −88.34 |
| 6-2FTS | −93.49 | −94.24 | −94.63 | −93.10 | −92.99 | −94.73 | −95.34 | −92.39 |
| PFOA | −91.59 | −94.48 | −94.40 | −91.67 | −92.39 | −93.68 | −95.63 | −90.44 |
| PFHpS | −93.18 | −95.45 | −95.45 | −93.18 | −93.18 | −95.45 | −100.0 | −88.64 |
| PFOS | −90.36 | −89.16 | −90.40 | −89.12 | −88.36 | −91.16 | −90.92 | −88.60 |
| PFNA | −92.08 | −93.86 | −94.46 | −91.49 | −92.57 | −93.37 | −95.05 | −90.89 |
| 8-2FTS | −89.89 | −82.46 | −86.73 | −85.62 | −83.57 | −88.78 | −87.35 | −85.00 |
| PFDA | −90.00 | −92.50 | −95.00 | −87.50 | −95.00 | −87.50 | −92.50 | −90.00 |
| Total | −92.44 | −94.16 | −94.27 | −92.33 | −92.56 | −94.05 | −95.34 | −91.26 |
| PFAS | | | | | | | | |

Ionic Strength/[OH—]

| | 1.4 g/L Ca(OH)₂ & | 0.14 g/L Ca(OH)₂ & |
|---|---|---|
| | 4.49 g/L NaAl(OH)₄ | 0.449 g/L NaAl(OH)₄ |
| PFBA | −89.26 | −94.79 |
| PFPeA | −92.40 | −96.56 |
| PFBS | −95.95 | −91.89 |
| 4-2FTS | −93.45 | −96.36 |
| PFHxA | −93.80 | −96.65 |
| PFHpA | −94.16 | −96.60 |
| PFHxS | −90.27 | −91.71 |
| 6-2FTS | −93.12 | −94.60 |
| PFOA | −91.75 | −94.32 |
| PFHpS | −97.73 | −90.91 |
| PFOS | −90.72 | −88.80 |
| PFNA | −92.38 | −93.56 |
| 8-2FTS | −87.80 | −84.55 |
| PFDA | −92.50 | −90.00 |
| Total | −92.38 | −94.22 |
| PFAS | | |

### Example 9: Regeneration with Surfactants and Agglomerating Agents on a Column

Spent F400 GAC is ground and packed into four (4) commercial chromatography columns (2.5 cm diameter). Each column was subjected to a regeneration process as set forth in Tables 22 and 23. Surfactants included SDS and PEG 300. Agglomerating agents included ethyl octanoate and canola oil. Where indicated, the agglomerating agent was positioned as a layer upstream of the column such that when the corresponding rinse was cycled (or recirculated) through the column, the fluid (or recirculated fluid) contacted the agglomerating agent prior to flowing through the column. For Rinse #4 of Columns 3 and 4, the agglomerating agent was included as a component of the rinse fluid.

TABLE 22
Regeneration processes for columns 1-4

| Rinse # | Column 1 | Column 2 | Column 3 | Column 4 |
|---|---|---|---|---|
| 1 | 0.1M NaOH | 0.1M NaOH | 0.1M NaOH | 0.1M NaOH |
| 2 | 6% H₂O₂ | 6% H₂O₂ | 6% H₂O₂ | 6% H₂O₂ |
| 3 | 4.49 g/L | 4.49 g/L | 4.49 g/L | 4.49 g/L |
| (recirculated) | NaAl(OH)₄ | NaAl(OH)₄ | NaAl(OH)₄ | NaAl(OH)₄ |
| | 0.1 wt % | 0.1 wt % | 0.1 wt % | 0.3 wt % |
| | Glycerol | Glycerol | Glycerol | Glycerol |
| | — | 0.1 wt % SDS | — | 0.3 wt % SDS |
| | — | — | 20 mL ethyl | 20 mL ethyl |
| | | | octanoate as a | octanoate as a |
| | | | layer on top | layer on top |
| 4 | 1.4 g/L | 1.4 g/L | 1.4 g/L | 1.4 g/L |
| (recirculated) | Ca(OH)₂ | Ca(OH)₂ | Ca(OH)₂ | Ca(OH)₂ |
| | 0.1 wt % | 0.1 wt % | 0.1 wt % | 0.3 wt % |
| | Glycerol | Glycerol | Glycerol | Glycerol |
| | — | 0.1 wt % PEG | — | 0.3 wt % PEG |
| | | 300 | | 300 |
| | — | — | 20 ml Ethyl | 20 ml Ethyl |
| | | | octanoate | octanoate |
| 5 | 0.1M Citric | 0.1M Citric | 0.1M Citric | 0.1M Citric |
| (recirculated) | acid buffer | acid buffer | acid buffer | acid buffer |
| | (pH 3) | (pH 3) | (pH 3) | (pH 3) |
| | — | — | — | 0.3 wt % SDS |
| 6 | DI water | Tap water | Tap water | Tap water |
| (500 BV) | | | | |

TABLE 23
Regeneration processes for columns 5-8

| Rinse # | Column 5 | Column 6 | Column 7 | Column 8 |
|---|---|---|---|---|
| 1 | 0.1M NaOH | 0.1M NaOH | 0.1M NaOH | 0.1M NaOH |
| 2 | 6% H₂O₂ | 6% H₂O₂ | 6% H₂O₂ | 6% H₂O₂ |
| 3 | 4.49 g/L | 4.49 g/L | 4.49 g/L | 4.49 g/L |
| (recirculated) | NaAl(OH)₄ | NaAl(OH)₄ | NaAl(OH)₄ | NaAl(OH)₄ |
| | 0.05 wt % | 0.05 wt % | 0.05 wt % | 0.3 wt % |
| | Glycerol | Glycerol | Glycerol | Glycerol |
| | — | 0.5 wt % PEG | — | 0.3 wt % PEG |
| | | 300 | | 300 |
| | — | — | 20 mL canola | 20 mL canola |
| | | | oil as a | oil as a |
| | | | layer on top | layer on top |
| 4 | 1.4 g/L | 1.4 g/L | 1.4 g/L | 1.4 g/L |
| (recirculated) | Ca(OH)₂ | Ca(OH)₂ | Ca(OH)₂ | Ca(OH)₂ |
| | 0.05 wt % | 0.05 wt % | 0.05 wt % | 0.3 wt % |
| | Glycerol | Glycerol | Glycerol | Glycerol |
| | — | 0.05 wt % PEG | — | 0.3 wt % PEG |
| | | 300 | | 300 |
| | — | — | 20 mL canola | 20 mL canola |
| | | | oil as a | oil as a |
| | | | layer on top | layer on top |
| 5 | HCl | HCl | HCl | HCl |
| (recirculated) | (pH 3, then | (pH 3, then | (pH 3, then | (pH 3, then |
| | 2, then 1) | 2, then 1) | 2, then 1) | 2, then 1) |
| | — | — | — | 0.3 wt % PEG |
| | | | | 300 |
| 6 | DI water | Tap water | Tap water | Tap water |
| (500 BV) | | | | |

As Rinse #6 (i.e., water rinse) was allowed to flow through each column, samples were taken periodically in a manner similar to that provided in Example 7. Specifically, computer-controlled sampling was achieved with a sampling valve (commercially available from VICI) in-line with the effluent drain. Sample water was diverted into a sample bottle at regular intervals. The samples were analyzed according to Environmental Protection Agency (EPA) Method 533. Upon completion of Rinse #6, each column was disassembled and the GAC was removed and separated from inert glass beads used to fill space and provide support for the carbon bed in the column. The separated GAC was then dried at low temperatures in a vacuum oven and extracted with methanol. The methanol was analyzed.

### Results:

TABLE 24
PFAS on GAC for columns 1-4

| | GAC mass | PFOA | PFOS | PFNA |
|---|---|---|---|---|
| | (mg, d.w.) | (μg/g) | (μg/g) | (μg/g) |
| Non-regen | 51.3 | 3.219 | 0.133 | 0.286 |
| Non-Regen | 48.7 | 2.546 | 0.139 | 0.247 |
| Duplicate | | | | |
| Column 1 | 49.9 | 4.599 | 0.185 | 0.419 |
| Column 2 | 50.1 | 2.912 | 0.155 | 0.286 |
| Column 3 | 49.2 | 3.520 | 0.188 | 0.329 |
| Column 4 | 51.5 | 2.284 | 0.139 | 0.231 |

TABLE 25
PFAS on GAC for columns 5-8

| | GAC mass | PFOA | PFOS | PFNA |
|---|---|---|---|---|
| | (mg, d.w.) | (μg/g) | (μg/g) | (μg/g) |
| Non-regen | 52.6 | 3.421 | 0.183 | 0.343 |
| Non-Regen | 51.4 | 2.777 | 0.145 | 0.314 |
| Duplicate | | | | |
| Column 5 | 51.1 | 2.302 | 0.108 | 0.242 |
| Column 6 | 49.5 | 2.048 | 0.103 | 0.185 |
| Column 7 | 51.3 | 1.865 | 0.92 | 0.191 |
| Column 8 | 52.5 | 2.234 | 0.126 | 0.231 |

TABLE 26
PFAS in post-regen water rinse for Column 4

| | PFHxA | PFHpA | PFOA | PFOS | PFNA |
|---|---|---|---|---|---|
| | (μg/L) | (μg/L) | (μg/L) | (μg/L) | (μg/L) |
| Tap | <0.01 | <0.01 | 0.025 | <0.01 | <0.01 |
| Influent | | | | | |
| Sample 1 | 0.711 | 0.390 | 0.831 | 0.031 | 0.055 |
| (15 BV) | | | | | |
| Sample 2 | 0.404 | 0.208 | 0.382 | <0.01 | 0.014 |
| (60 BV) | | | | | |
| Sample 3 | 0.390 | 0.196 | 0.366 | 0.014 | 0.020 |
| (110 BV) | | | | | |
| Sample 4 | 0.338 | 0.170 | 0.204 | <0.01 | <0.01 |
| (500 BV) | | | | | |

TABLE 27
PFAS in post-regen water rinse for Column 7

| | PFHxA | PFHpA | PFOA | PFOS | PFNA |
|---|---|---|---|---|---|
| | (μg/L) | (μg/L) | (μg/L) | (μg/L) | (μg/L) |
| Tap | <0.01 | <0.01 | 0.049 | <0.01 | <0.01 |
| Influent | | | | | |
| Tap | <0.01 | <0.01 | 0.048 | <0.01 | <0.01 |
| Influent | | | | | |
| Duplicate | | | | | |
| Sample 1 | 0.039 | 0.011 | 0.022 | <0.01 | <0.01 |
| (15 BV) | | | | | |
| Sample 2 | 0.031 | 0.009 | 0.022 | <0.01 | <0.01 |
| (60 BV) | | | | | |
| Sample 3 | 0.043 | 0.011 | 0.023 | <0.01 | <0.01 |
| (110 BV) | | | | | |
| Sample 4 | <0.01 | <0.01 | 0.049 | <0.01 | <0.01 |
| (500 BV) | | | | | |

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of removing a contaminant from an aqueous mixture, the method comprising:
flowing a contaminated aqueous mixture comprising one or more ionic contaminants through a vessel that houses a carbon bed, wherein the one or more ionic contaminants are retained by the carbon bed;
contacting the one or more ionic contaminants retained by the carbon bed with (a) a hydroxide and/or a peroxide, and (b) one or more cations selected from Ca²⁺, Mg²⁺, Zn²⁺, Sr²⁺, Al³⁺, B³⁺, and Fe³⁺;
wherein the (a) hydroxide and/or peroxide, and the (b) one or more cations are provided in a single aqueous liquid or in two or more separate aqueous liquids for contacting the one or more ionic contaminants;
forming an aggregate contaminant phase comprising the one or more ionic contaminants; and
isolating the aggregate contaminant phase.

2. The method of claim 1, wherein the aggregate contaminant phase is formed by precipitation, micelle formation, agglomeration, flocculation, flotation, or breaking an emulsion.

3. The method of claim 1, wherein the (a) hydroxide and/or peroxide comprises sodium hydroxide.

4. The method of claim 1, wherein the (a) hydroxide and/or peroxide comprises hydrogen peroxide.

5. The method of claim 1, wherein the (a) hydroxide and/or peroxide comprises sodium peroxide.

6. The method of claim 1, wherein the (b) one or more cations comprises Ca²⁺.

7. The method of claim 6, wherein the Ca²⁺ is provided as calcium hydroxide.

8. The method of claim 1, wherein the (b) one or more cations comprises Al³⁺.

9. The method of claim 8, wherein the Al³⁺ is provided as aluminum sulfate, aluminum hydroxide, or sodium aluminate.

10. The method of any one of claims 1-9, wherein the (a) hydroxide and/or peroxide are provided in a first aqueous liquid; and wherein the (b) one or more cations are provided in a second aqueous liquid.

11. The method of claim 10, wherein the first aqueous liquid contacts the one or more ionic contaminants before the second aqueous liquid.

12. A method of removing a contaminant from an aqueous mixture, the method comprising:
flowing a contaminated aqueous mixture comprising one or more ionic contaminants through a vessel that houses an carbon bed, wherein the one or more ionic contaminants are retained by the carbon bed;
contacting the one or more ionic contaminants retained by the carbon bed with (a) sodium hydroxide and/or hydrogen peroxide, and (b) calcium hydroxide, aluminum hydroxide, and/or aluminum sulfate;
wherein the (a) sodium hydroxide and/or hydrogen peroxide, and the (b) calcium hydroxide, aluminum hydroxide, and/or aluminum sulfate are provided in a single aqueous liquid or in two or more separate aqueous liquids for contacting the one or more ionic contaminants;
forming an aggregate contaminant phase comprising the one or more ionic contaminants; and
isolating the aggregate contaminant phase.

13. The method of claim 12, wherein (a) sodium hydroxide and/or hydrogen peroxide are provided in a first aqueous liquid for contacting the one or more ionic contaminants; and wherein (b) calcium hydroxide, aluminum hydroxide, and/or aluminum sulfate are provided in a second aqueous liquid for contacting the one or more ionic contaminants.

14. The method of claim 13, wherein the first aqueous liquid contacts the ionic contaminants before the second aqueous liquid.

15. The method of any one of claims 1-14, further comprising rinsing the carbon bed with an acidic aqueous solution by flowing the acidic aqueous solution through the vessel.

16. The method of claim 15, wherein the acidic aqueous solution comprises hydrochloric acid, citric acid, sulfuric acid, nitric acid, or any combination thereof.

17. The method of claim 15, wherein the acidic aqueous solution comprises an acid salt.

18. The method of any one of claims 1-17, further comprising rinsing the carbon bed with water by flowing water through the vessel.

19. The method of claim 18, wherein the water is substantially free of additives.

20. The method of any one of claims 1-19, further comprising repeating one or more times the steps of (i) contacting the ionic contaminants with the (a) hydroxide and/or peroxide, (ii) contacting the ionic contaminants with the (b) one or more cations, (iii) rinsing with the acidic aqueous solution, and (iv) rinsing with water.

21. The method of any one of claims 1-20, wherein, prior to flowing the contaminated aqueous mixture through the vessel, the method further comprises pretreating the carbon bed by contacting the carbon bed with (a) a hydroxide and/or a peroxide, and (b) one or more cations selected from Ca²⁺, Mg²⁺, Zn²⁺, Sr²⁺, Al³⁺, B³⁺, and Fe³⁺.

22. The method of claim 21, wherein the pretreatment further comprises rinsing the carbon bed with an acidic aqueous solution and rinsing the carbon bed with water.

23. The method of any one of claims 1-22, wherein the ionic contaminant comprises an organic end with an ionic moiety.

24. The method of any one of claims 1-23, wherein the ionic contaminant is selected from the group consisting of a polyfluoroalkyl ion, a borate, a phosphate, a polyphosphate, a sulfate, an organic acid, a fatty acid, a humic substance, a shortchain PFAS, a water-soluble medication, a detergent, a water-soluble insecticide, a water-soluble fungicide, a water-soluble germicide, and any combination thereof.

25. The method of claim 24, wherein the ionic contaminant is a polyfluoroalkyl ion.

26. The method of claim 25, wherein the polyfluoroalkyl ion is perfluorooctanesulfonate or perfluorooctanoate.

27. The method of any one of claims 1-26, wherein the carbon bed comprises powder, granules, beads, pellets, cloths, felts, nonwoven fabrics, or composites comprising a material selected from carbon, nitrogen-doped carbon, silicon-doped carbon, boron-doped carbon, charcoal, graphite, biochar, coke, carbon black, or any combination thereof.

28. The method of claim 27, wherein the carbon bed comprises activated charcoal powder, granules, pellets, beads, or any combination thereof.

29. The method of any one of claims 1-28, wherein the vessel is a pipe, column, or tank.

30. The method of any one of claims 1-29, wherein isolating the aggregate contaminant phase comprises filtration, nano-filtration, or sedimentation.

31. The method of any one of claims 1-30, further comprising contacting the one or more ionic contaminants with a surfactant.

32. The method of claim 31, wherein the surfactant is selected from fatty acids, sulphones, phosphates, polyethers, sulfates, polyols, or any combination thereof.

33. The method of claim 32, wherein the surfactant is selected from sodium dodecyl sulfate (SDS), sorbitan monolaurate, polyethylene glycol (PEG), or any combination thereof.

34. The method of any one of claims 31-33, wherein the surfactant contacts the one or more ionic contaminants before the (a) hydroxide and/or peroxide contact the one or more ionic contaminants.

35. The method of any one of claims 31-33, wherein the surfactant contacts the one or more ionic contaminants after the (a) hydroxide and/or peroxide contact the one or more ionic contaminants.

36. The method of any one of claims 1-35, further comprising contacting the one or more ionic contaminants with an agglomerating agent.

37. The method of claim 36, wherein the agglomerating agent comprises an oil, a terpene, a fatty acid ester, or any combination thereof.

38. The method of claim 37, wherein the agglomerating agent is selected from safflower oil, rapeseed oil, limonene, ethyl octanoate, or any combination thereof.

39. The method of any one of claims 36-38, wherein the agglomerating agent contacts the one or more ionic contaminants before the (a) hydroxide and/or peroxide contact the one or more ionic contaminants.

40. The method of any one of claims 36-38, wherein the agglomerating agent contacts the one or more ionic contaminants after the (a) hydroxide and/or peroxide contact the one or more ionic contaminants.

41. The method of any one of claims 1-40, wherein the carbon bed is an activated carbon bed.

42. The method of any one of claims 1-40, wherein the carbon bed comprises sintered carbon.

43. A method of regenerating a carbon bed, the method comprising:
providing a vessel that houses an carbon bed having one or more ionic contaminants retained thereon or therein;
contacting the one or more ionic contaminants retained by the carbon bed with (a) a hydroxide and/or a peroxide, and (b) one or more cations selected from Ca²⁺, Mg²⁺, Zn²⁺, Sr²⁺, Al³⁺, B³⁺, and Fe³⁺;
wherein the (a) hydroxide and/or peroxide, and the (b) one or more cations are provided in a single aqueous liquid or in two or more separate aqueous liquids for contacting the one or more ionic contaminants;
forming an aggregate contaminant phase comprising the one or more ionic contaminants; and
isolating the aggregate contaminant phase.

44. A method of removing a contaminant from an aqueous mixture, the method comprising:
flowing a contaminated aqueous mixture comprising one or more ionic contaminants through a vessel that houses a carbon bed, wherein the one or more ionic contaminants are retained by the carbon bed;
contacting the one or more ionic contaminants retained by the carbon bed with (a) a hydroxide and/or a peroxide, and (b) one or more cations selected from Ca²⁺, Mg²⁺, Zn²⁺, Sr²⁺, Al³⁺, B³⁺, and Fe³⁺;
wherein the (a) hydroxide and/or peroxide, and the (b) one or more cations are provided in a single aqueous liquid or in two or more separate aqueous liquids for contacting the one or more ionic contaminants;
contacting the one or more ionic contaminants with an agglomerating agent;
forming an aggregate contaminant phase comprising the one or more ionic contaminants; and
isolating the aggregate contaminant phase.

45. The method of claim 44, wherein the agglomerating agent comprises an oil, a terpene, a fatty acid ester, or any combination thereof.

46. The method of claim 45, wherein the agglomerating agent comprises the oil, and wherein the oil is selected from coconut oil, corn oil, cottonseed oil, olive oil, palm oil, peanut oil, rapeseed oil, safflower oil, sesame oil, soybean oil, sunflower oil, or any combination thereof.

47. The method of claim 45, wherein the agglomerating agent comprises the terpene, and wherein the terpene is selected from myrcene, menthol, limonene, carvone, hinokitiol, linalool, or any combination thereof.

48. The method of claim 45, wherein the agglomerating agent comprises the fatty acid ester, and wherein the fatty acid ester is ethyl octanoate.

49. The method of claim 45, wherein the agglomerating agent is selected from safflower oil, rapeseed oil, limonene, ethyl octanoate, or any combination thereof.

50. The method of any one of claims 44-49, further comprising contacting the one or more ionic contaminants with a surfactant.

51. The method of claim 52, wherein the surfactant is selected from fatty acids, sulphones, phosphates, polyethers, sulfates, polyols, or any combination thereof.

52. The method of claim 53, wherein the surfactant is selected from sodium dodecyl sulfate (SDS), sorbitan monolaurate, polyethylene glycol (PEG), or any combination thereof.

53. The method of any one of claims 44-52, further comprising contacting the one or more ionic contaminants with an antifreeze agent.

54. The method of claim 53, wherein the antifreeze agent is selected from the group consisting of propylene glycol, polypropylene glycol, polyethylene glycol, glycerol, polyvinyl alcohol, carboxymethylcellulose, ribose, sucrose, glucose, rhamnose, xylose, fructose, raffinose, stachyose, low molecular weight hydroxyethyl starches, maltodextrin, cellodextrins, and combinations thereof.

55. The method of claim 53, wherein the antifreeze agent comprises glycerol.

56. The method of any one of claims 44-55, further comprising rinsing the carbon bed with an acidic aqueous solution by flowing the acidic aqueous solution through the vessel.

57. The method of claim 56, wherein the acidic aqueous solution comprises hydrochloric acid, citric acid, sulfuric acid, nitric acid, or any combination thereof.

58. The method of claim 56, wherein the acidic aqueous solution comprises an acid salt.

59. The method of any one of claims 44-58, wherein (a) hydroxide and/or peroxide are provided in a first aqueous liquid for contacting the one or more ionic contaminants; and wherein (b) the one or more cations are provided in a second aqueous liquid for contacting the one or more ionic contaminants.

60. The method of claim 59, wherein the second aqueous liquid further comprises the surfactant and the antifreeze agent.

61. The method of claim 59 or 60, wherein the first aqueous liquid contacts the one or more ionic contaminants before the second aqueous liquid.

62. The method of any one of claims 44-61, wherein the agglomerating agent is provided as a layer of agglomerating agent downstream of the vessel.

63. A method of removing a contaminant from an aqueous mixture, the method comprising:
flowing a contaminated aqueous mixture comprising one or more ionic contaminants through a vessel that houses a carbon bed, wherein the one or more ionic contaminants are retained by the carbon bed;
contacting the one or more ionic contaminants retained by the carbon bed with (a) a hydroxide and/or a peroxide, and (b) one or more cations selected from Ca²⁺, Mg²⁺, Zn²⁺, Sr²⁺, Al³⁺, B³⁺, and Fe³⁺;
wherein the (a) hydroxide and/or peroxide, and the (b) one or more cations are provided in a single aqueous liquid or in two or more separate aqueous liquids for contacting the one or more ionic contaminants;
contacting the single aqueous liquid or two or more separate aqueous liquids with an agglomerating agent to form an aggregate contaminant phase comprising the one or more ionic contaminants after contacting the one or more ionic contaminants retained by the carbon bed with the (a) hydroxide and/or peroxide and the (b) one or more cations; and
isolating the aggregate contaminant phase.
